(19) United States
(12) Patent Application Publication
(10) Pub. No.: US 2025/0374058 A1
(43) Pub. Date: Dec. 4, 2025

(54) SYSTEMS, APPARATUS, ARTICLES OF MANUFACTURE, AND METHODS FOR DEVICE AUTHENTICATION IN A DEDICATED PRIVATE NETWORK

(71) Applicant: Intel Corporation, Santa Clara, CA (US)

(72) Inventors: Stephen Palermo, Chandler, AZ (US); Roya Doostnejad, Los Altos, CA (US); Valerie Parker, Portland, OR (US); Soo Jin Tan, Shanghai (CN); Jose De Jesus Cuallo-Amador, Phoenix, AZ (US)

(73) Assignee: Intel Corporation, Santa Clara, CA (US)

(21) Appl. No.: 18/868,648

(22) PCT Filed: Jun. 28, 2023
(86) PCT No.: PCT/US2023/026468

§ 371 Date: Nov. 22, 2024

(30) Foreign Application Priority Data
Jun. 28, 2022 (WO) PCT/CN2022/101922

(51) Int. Cl. H04W 12/30; H04W 12/63

(52) U.S. Cl. CPC H04W 12/35; H04W 12/63

(57) ABSTRACT

Methods, apparatus, systems, and articles of manufacture are disclosed for device authentication in a dedicated private network. An example apparatus includes interface circuitry, machine readable instructions, and programmable circuitry to utilize the machine readable instructions to generate first credentials associated with a first network based on second credentials associated with a second network, the first credentials including first location data corresponding to a dedicated private network (DPN), cause a mobile device to program a programmable subscriber identity module (SIM) of the mobile device based on the first credentials, and permit the mobile device to access the DPN based on a determination that second location data corresponding to the mobile device and included with the programmable SIM corresponds to the first location data.

### RELATED APPLICATION

This patent claims the benefit of International Application No. PCT/CN2022/101922, which was filed on Jun. 28, 2022. International Application No. PCT/CN2022/101922 is hereby incorporated herein by reference in its entirety. Priority to International Application No. PCT/CN2022/101922 is hereby claimed.

### FIELD OF THE DISCLOSURE

This disclosure relates generally to networks and, more particularly, to systems, apparatus, articles of manufacture, and methods for device authentication in a dedicated private network.

### BACKGROUND

Private networks are emerging to serve enterprise, government, and education segments. Private networks can be established using licensed, unlicensed, or shared spectrum. Private networks can be optimized for specific enterprise needs including network access, network performance, and isolation from public networks. Private networks can be deployed with or without traditional communication service providers whereas public networks are deployed with traditional communication service providers.

### BRIEF DESCRIPTION OF THE DRAWINGS

FIG. 1A is an illustration of an example system including an example dedicated private network (DPN).

FIG. 1B is an illustration of another example system including an example multi-wireless access controller.

FIG. 2 is a block diagram of an example implementation of the DPN of FIG. 1A.

FIG. 3 is a first example workflow to register an example device illustrated in FIG. 1A with the example DPN of FIG. 1A using a first example Wi-Fi infrastructure illustrated in FIG. 1A.

FIG. 4 is a second example workflow to register the example device of FIG. 1A with the example DPN of FIG. 1A using an example Non-3GPP Inter-Working Function (N3IWF) illustrated in FIG. 1A.

FIG. 5 is a third example workflow to register the example device of FIG. 1A with the example DPN of FIG. 1A using trusted 3GPP access over the Trusted Non-3GPP Access Point (TNAP) and the Trusted Non-3GPP Gateway Function (TNGF) of FIG. 1A.

FIG. 6 is a fourth example workflow to register the example device of FIG. 1A with the example DPN of FIG. 1A using a hardcoded identifier of a device that has been pre-registered with the DPN of FIG. 1A.

FIG. 7 depicts the example DPN of FIG. 1A authenticating private network access requested by example devices.

FIG. 8 illustrates an overview of an example edge cloud configuration for edge computing that may implement the examples disclosed herein.

FIG. 9 illustrates operational layers among example endpoints, an example edge cloud, and example cloud computing environments that may implement the examples disclosed herein.

FIG. 10 illustrates an example approach for networking and services in an edge computing system that may implement the examples disclosed herein.

FIG. 11 depicts an example edge computing system for providing edge services and applications to multi-stakeholder entities, as distributed among one or more client compute platforms, one or more edge gateway platforms, one or more edge aggregation platforms, one or more core data centers, and a global network cloud, as distributed across layers of the edge computing system.

FIG. 12 illustrates a drawing of a cloud computing network, or cloud, in communication with a number of Internet of Things (IoT) devices, according to an example.

FIG. 13 illustrates network connectivity in non-terrestrial network (NTN) supported by a satellite constellation and a terrestrial network (e.g., mobile cellular network) settings, according to an example.

FIG. 14 is a flowchart representative of example machine readable instructions and/or example operations that may be executed by example processor circuitry to implement the DPN of FIG. 2 to facilitate communication associated with user equipment using a private network.

FIG. 15 is a flowchart representative of example machine readable instructions and/or example operations that may be executed by example processor circuitry to implement the DPN of FIG. 2 to facilitate communication associated with user equipment based on location verification.

FIG. 16 is another flowchart representative of example machine readable instructions and/or example operations that may be executed by example processor circuitry to implement the DPN of FIG. 2 to facilitate communication associated with user equipment based on location verification.

FIG. 17 is yet another flowchart representative of example machine readable instructions and/or example operations that may be executed by example processor circuitry to implement the DPN of FIG. 2 to facilitate communication associated with user equipment based on location verification.

FIG. 18 is a flowchart representative of example machine readable instructions and/or example operations that may be executed by example processor circuitry to implement the DPN of FIG. 2 to validate access to a private network by a device.

FIG. 19 illustrates a block diagram for an example IoT processing system architecture upon which any one or more of the techniques (e.g., operations, processes, methods, and methodologies) discussed herein may be performed, according to an example.

FIG. 20 is a block diagram of an example processing platform including processor circuitry structured to execute and/or instantiate the example machine-readable instructions and/or the example operations of FIGS. 14-18 to implement the example DPN of FIG. 2.

FIG. 21 is a block diagram of an example implementation of the processor circuitry of FIGS. 19 and/or 20.

FIG. 22 is a block diagram of another example implementation of the processor circuitry of FIGS. 19 and/or 20.

FIG. 23 is a block diagram of an example software distribution platform (e.g., one or more servers) to distribute software (e.g., software corresponding to the example machine readable instructions of FIGS. 14-18) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time +/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

Private networks are emerging to serve enterprise, government, and education segments. Private networks can be established using licensed, unlicensed, or shared spectrum. Private networks can be optimized for specific enterprise needs including network access, network performance, and isolation from public networks. Private networks can be deployed with or without traditional communication service providers whereas public networks are deployed with traditional communication service providers.

Private networks can be completely isolated from a traditional network maintaining all network nodes and services on-premises including a next generation radio access network (NG-RAN) supporting multi-access connectivity, control, user plane functionality, subscriber databases, and next generation core (NG-CORE) network capabilities. Private network access is typically handled by public land mobile network (PLMN) operators providing wireless communication services in a specific country and/or a Global Mobile Satellite System (GMSS) providing satellite services to customers. A PLMN ID is made up of a Mobile Country Code (MCC) and Mobile Network Code (MNC). MCCs are three digits and MNCs are two to three digits and enable user equipment or user equipment devices (UEs) to connect to the operators gNodeBs (gNBs) on cell towers. GMSS is similar to PLMNs for satellite non-terrestrial networks.

Access to public networks is known and specifications from the 3rd Generation Partnership Project (3GPP) allow user equipment devices (e.g., UEs) to connect and interact among networks owned by different communication service providers. Isolated private networks can replicate the same 3GPP procedures and functions to reuse existing 3GPP specifications and maintain UE compatibility. Public and private networks coverage can overlap-overlapping Private/Private PLMNs, overlapping Private/Public GMSSs-thereby providing a UE with multiple connection options when the UE is within multiple overlapping network cells. However, such overlaps can create difficulty when the public and private networks are incompatible with each other and/or otherwise configured differently or based on different standards.

Moreover, Wireless Fidelity (Wi-Fi) and fifth generation cellular (5G) access credential (or login credential) generation and registration remain separate and independent processes from each other. Despite an example in which a dedicated private network (DPN) can offer both Wi-Fi and 5G connectivity, the access credential generation and registration (e.g., validation, authentication, etc.) are handled separately. Handling such tasks separately requires a network operator to handle them with two different processes. Likewise for a UE, the UE undergoes two different processes to register the UE device onto both Wi-Fi and 5G networks.

For UE network login or access, the UE can be authenticated through a programmable Subscriber Identity Module (SIM) card (e.g., an eSIM) or a physical SIM card inserted into the UE, but network registration of both (e.g., the eSIM and physical SIM) also needs to be carried out manually (e.g., with human operation or intervention). For physical SIM card registration, a network operator burns a physical SIM (e.g., affixing a non-configurable integrated circuit on a removable universal integrated circuit card), which requires additional cost and human resources to do so. For example, the SIM card can be burnt using a physical SIM card burner. In some examples, the SIM card can be burnt with an identifier (ID) that has been pre-registered with a core network of the network provider. The physical SIM can be distributed and slotted manually into the SIM card holder of the UE device before the UE is able to register with the network provider. Although it may be a onetime effort, such a manually intensive process can create significant inconveniencies for a user associated with a UE or an Internet of Things (IoT) device as they may only temporarily log onto and/or otherwise access a network of the network provider. For example, significant resources can be expended by burning the new SIM, installing the SIM in a UE, and then disposing the SIM shortly after using, which is inherently wasteful. Such a process can expense substantial logistics efforts (e.g., when burning physical SIMs for hundreds or thousands of devices) and additional expenses. Such a process is not environmentally friendly due to the limited use and subsequent disposal of the SIM card, especially for guest visitors who may temporarily connect to the network for a limited period of time. In addition, eSIM implementations are based on the consideration towards the application in public networks, with handover among different authorized PLMNs during roaming to maintain connectivity. Such eSIM implementations for public networks do not translate to private network implementations.

Examples disclosed herein can effectuate device authentication in a dedicated private network (DPN). In some disclosed examples, a DPN is a network-as-a-service private network solution, which can provide multi-spectrum connectivity (e.g., 5G and Wi-Fi connectivity). In some disclosed examples, a DPN is a convergence of Operational Technology (OT), Information Technology (IT), and Communications Technology (CT) to support consumer and/or machine types of connectivity over 5G or Wi-Fi. However, connections to either 5G networks or Wi-Fi networks are typically done manually and separately using different sets of login credentials. In a Wi-Fi example, Non-Trusted 3GPP Access over N3IWF and Trusted 3GPP Access over TNAP/TNGF are managed through the AMF as part of the 5G Core (5GC), but the login to 5G gNB requires a physical SIM to be inserted into the UE and authenticated separately. Separate authentications create extra steps and especially when the UE is an IoT device such as cellular-enabled sensors, cameras, automated guided vehicle (AGV), an autonomous mobile robot (AMR), etc.

In some disclosed examples, private networks (e.g., fifth generation cellular or sixth generation cellular (5G or 6G)) may be deployed within fixed geographical boundaries of an enterprise and provide multiple coverage cells that provide connectivity to UEs. A private network associated with a fixed geographical boundary of an enterprise or other entity is referred to herein as a dedicated private network. For example, a dedicated private network can be configured and operated to serve a specified geographical area and a specified number and/or type of authorized devices. In some examples, the authorized devices are pre-authorized to join the dedicated private network prior to operation of the dedicated private network.

Examples disclosed herein include example DPN circuitry, which can implement private network instances (e.g., 5G network instances, Wi-Fi network instances, satellite network instances, etc.), such as 5G new radio-radio access network (NR-RAN) and 5G core network (5G-CN) as well as all the required modules and interfaces. Advantageously, example DPN circuitry can implement an isolated private network. Examples disclosed herein include example DPN circuitry to obtain and use the UE location to qualify and enforce UE access on the private network according to private network policy. For example, example DPN circuitry can embed location data associated with a DPN in the eSIM. In some examples, example DPN circuitry can authorize access by a UE utilizing the eSIM to a DPN based on verifying that the location data of the eSIM is associated with the DPN. For example, example DPN circuitry can record eSIM location detections for traceability of movements and authentication of locations.

Examples disclosed herein utilize an eSIM to login into a DPN using a single set of login credentials that can be provisioned through a particular spectrum such as Wi-Fi. In some disclosed examples, the single set of login credentials can originate from a Wi-Fi access point (AP) controller then handed over to a Multi-Wireless Access Controller (MWAC). In some disclosed examples, the single set of login credentials can be generated from Wi-Fi login credentials and managed through an MWAC shared between a 5G network and a Wi-Fi network. In some disclosed examples, during eSIM generation, location data can be embedded from an LMF into the eSIM through an MWAC. In such examples, the location data embedded in the eSIM can be verified as part of the authentication among AMF, Unified Data Management (UDM), and Authentication Server Function (AUSF). In some disclosed examples, an AMF can engage (e.g., constantly, iteratively, periodically, aperiodically, etc., engage) in a handshake with an eSIM to cross verify location data between what has previously been embedded in the eSIM and location data from an LMF. In some disclosed examples, an eSIM can be provisioned over Non-3GPP defined modules including N3IWF and TNGF gateways as defined by 3GPP as an example alternative to an independent Wi-Fi AP Controller.

In some disclosed examples, example DPN circuitry can enable instantaneous data and measurements required for network initiated UE location detection. In some disclosed examples, example DPN circuitry can ensure instant (or near or approximately instant) access to information needed for the lowest latency and highest location result periodicity possible for access related DPN private network policy decisions. For example, example DPN circuitry can utilize location detection to enable UEs to register with a specific private network PLMN. Advantageously, examples disclosed herein include terrestrial and non-terrestrial network instances supporting 3GPP, Open Radio Access Network (O-RAN), and/or NON-3GPP architectures.

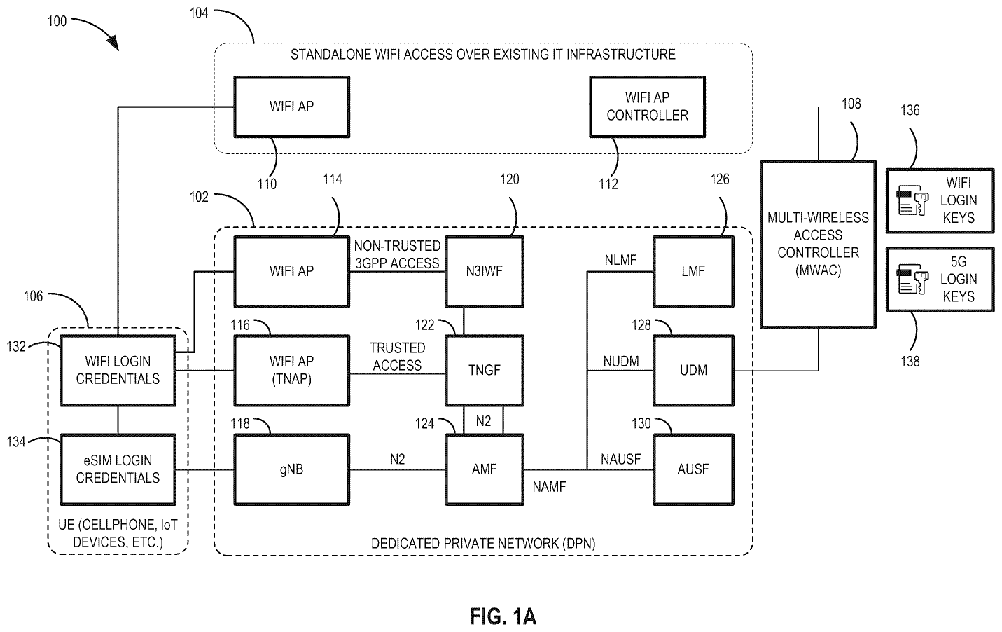

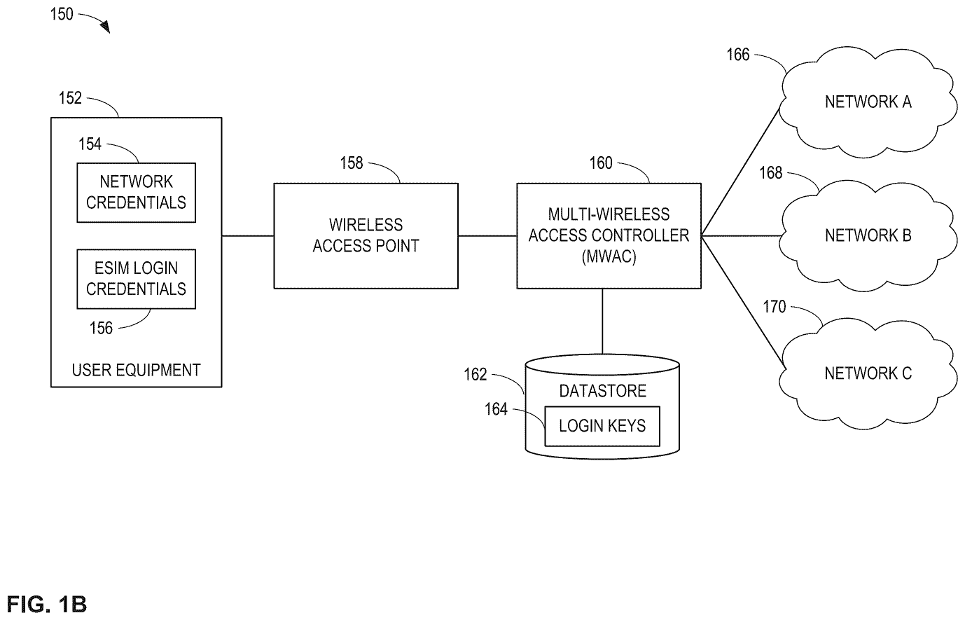

FIG. 1A is an illustration of an example system 100 including an example dedicated private network (DPN) 102, a first example Wi-Fi infrastructure 104, an example device 106, an example multi-wireless access controller (MWAC) 108. The first Wi-Fi infrastructure 104 includes a first example Wi-Fi access point (AP) 110 and an example Wi-Fi AP controller 112. In some examples, the first Wi-Fi infrastructure 104 can be an independent Wi-Fi network from the DPN 102. For example, both the control plane and the data plane of the first Wi-Fi infrastructure 104 can be isolated from the DPN 102.

The first Wi-Fi AP 110 is coupled to the Wi-Fi AP controller 112. The first Wi-Fi AP 110 is in communication and/or otherwise communicatively coupled to the device 106 via a wireless connection (e.g., a Wi-Fi connection). The Wi-Fi AP controller 112 is coupled to the MWAC 108. For example, the Wi-Fi AP controller 112 can be in communication and/or otherwise communicatively coupled to the MWAC 108 via a wired or wireless connection. The MWAC 108 of the illustrated example can be implemented by hardware, software, and/or firmware to effectuate access of the device 106 to one or more spectrums, such as Wi-Fi, 5G, satellite, Bluetooth, etc.

In some examples, the DPN 102 can be an instance of a private network. For example, the DPN 102 can include, execute, and/or otherwise instantiate one or more functions, services, etc., to manage and/or operate a private network (e.g., a private cellular network, a private Wi-Fi network, etc., and/or any combination(s) thereof. In some examples, the DPN 102 is a dedicated private network because the DPN 102 is configured (or configurable) to handle communication or data related requests by user equipment, such as the device 106, in connection with a fixed or known geographical area, boundary, zone, etc.

In some examples, the hardware, software, and/or firmware that implements the DPN 102 is included in a single housing or enclosure. For example, the hardware, software, and/or firmware that implements the DPN 102 is included in a housing or enclosure that is situated at a fixed location at an enterprise or other entity. Additionally or alternatively, the hardware, software, and/or firmware that implements the DPN 102 is included in a housing or enclosure that is mobile and may be carried around by one or more individuals. For example, the DPN 102 may be included in a backpack sized housing or enclosure. In some examples, the hardware that implements the DPN 102 may modular such that an enterprise utilizing the DPN 102 can swap out different modules based on the usage and/or priorities of the enterprise. For example, the modules of the DPN 102 may be implemented by hardware accelerators on integrated circuit cards (e.g., a network interface card, a location management function card, a unified data management function card, an authentication server function card, etc.).

In the illustrated example of FIG. 1A, the DPN 102 includes a second example Wi-Fi AP 114, a third example Wi-Fi AP 116, and an example gNodeB 118. In the illustrated example, the second Wi-Fi AP 114 effectuates and/or otherwise implements non-trusted 3GPP access. In the example of FIG. 1A, the third Wi-Fi AP 116 effectuates and/or otherwise implements trusted access. For example, the third Wi-Fi AP 116 can be a Trusted Non-3GPP Access Point (TNAP). In the example of FIG. 1A, the gNodeB 118 is a 5G radio base station.

In the illustrated example of FIG. 1A, the DPN 102 of the illustrated example includes an example Non-3GPP Inter-Working Function (N3IWF) 120, an example Trusted Non-3GPP Gateway Function (TNGF) 122, an example Access and Mobility Management Function (AMF) 124, an example Location Management Function (LMF) 126, an example Unified Data Management (UDM) function 128, and an example Authentication Server Function (AUSF) 130. In the example of FIG. 1A, the second Wi-Fi AP 114 is coupled to the N3IWF 120. In the example of FIG. 1A, the third Wi-Fi AP 116 is coupled to the TNGF 122. In the example of FIG. 1A, the gNB 118, the N3IWF 120, and the TNGF 122 are coupled to the AMF 124 via an N2 interface.

In the illustrated example of FIG. 1A, the AMF 124 has an AMF interface (identified by Namf). In the example of FIG. 1A, the LMF 126 has an LMF interface (identified by Nlmf). The example UDM 128 of the illustrated example has a UDM interface (identified by Nudm). In the example of FIG. 1A, the AUSF 130 has an AUSF interface (identified by Nausf). In the example of FIG. 1A, the UDM 128 is in communication (e.g., communicatively coupled) to the MWAC 108. For example, the UDM 128 can be coupled to the MWAC 108 via a wired or wireless connection.

In the illustrated example of FIG. 1A, the device 106 is a user equipment (UE) device. For example, the device 106 can be a cellphone (e.g., an Internet and/or 5G enabled smartphone), an IoT device, an autonomous vehicle, industrial equipment, etc. The device 106 of FIG. 1A has first example access credentials 132 and second example access credentials 134. In the example of FIG. 1A, the first access credentials 132 are Wi-Fi login credentials, which can be used to access and/or otherwise utilize a Wi-Fi network. For example, the device 106 can provide the Wi-Fi login credentials to the first Wi-Fi AP 110, the second Wi-Fi AP 114, and/or the third Wi-Fi AP 116 to secure access to a Wi-Fi network, such as a private Wi-Fi network managed by the DPN 102. In the example of FIG. 1A, the second access credentials 134 are eSIM login credentials, which can be used to access and/or otherwise utilize a cellular network (e.g., a 5G/6G network). For example, the device 106 can provide the second access credentials 134 to the gNB 118 to secure access to a private cellular network managed by the DPN 102. In some examples, the eSIM implements a programmable SIM card. For example, the eSIM can be software installed onto an embedded universal integrated circuit card (eUICC) attached to and/or otherwise included in the device 106.

In some examples, the DPN 102 can configure the eSIM based on example Wi-Fi login keys 136, which can correspond to the first access credentials 132. For example, the Wi-Fi login keys 136 can be created and/or otherwise provided by an Information Technology (IT) network or the DPN 102. Additionally, the DPN 102 can generate example 5G login keys 138, which can correspond to the second access credentials 134. In the example of FIG. 1A, the DPN 102 can generate the 5G login keys 138 based on the Wi-Fi login keys 136. After the 5G login keys 138 are generated, the DPN 102 can provision the 5G login keys 138 as the second access credentials 134 over the Wi-Fi network for the device 106 to register onto the DPN 102.

In some examples, the DPN 102 can embed location data into the second access credentials 134. For example, the DPN 102 can be associated with a fixed geographical area identifiable by location data (e.g., Global Positioning System (GPS) coordinates or any other type of location data). In some examples, the DPN 102 can include the location data into the 5G login keys 138. For example, the DPN 102 can provide the second access credentials 134, which can include the location data, to the device 106. In some examples, the device 106 can provide the second access credentials 134, along with the embedded location data, to the gNB 118 for access to the DPN 102. In the example of FIG. 1A, the DPN 102 can compare the embedded location data of the second access credentials 134 to the location data associated with the DPN 102. After a determination that the embedded location data is associated with, part of, or is a match (e.g., a partial match) to the location data associated with the DPN 102, the DPN 102 can grant access to the device 106 to utilize the DPN 102.

Advantageously, in some examples, the eSIM of the device 106 can be associated with the location data of the DPN 102 as an enhanced security feature to ensure that all of the data exchange only occurs when the device 106 operates within a permitted perimeter, such as within a specified factory or building. In some examples, a 5G core of the DPN 102, which can be implemented by the LMF 126 and/or the AMF 124, can periodically (or aperiodically) initiate a handshake with the location verified eSIM of the device 106 to cross check with the location data embedded into the eSIM to ensure that the eSIM matches the correct ID as registered into it (e.g., the ID registered into the eSIM by the DPN 102). Advantageously, the DPN 102 can effectuate a streamlined authentication and hassle-free process login into the DPN 102 using assigned Wi-Fi login credentials with an eSIM without manual and/or physical SIM card installation. Advantageously, users do not need to maintain two separate sets of login credentials (e.g., a first set of login credentials including a Wi-Fi username and password and a second set of login credentials such as a SIM card).

FIG. 1B is an illustration of another example system 150 including example user equipment (UE) 152, an example wireless access point 158, an example multi-wireless access controller (MWAC) 160, an example datastore 162, a first example network 166 (identified by NETWORK A), a second example network 168 (identified by NETWORK B), and a third example network 170 (identified by NETWORK C). In some examples, the wireless access point 158 and/or the MWAC 160 can implement a dedicated private network as disclosed herein.

The UE 152 can be any type of electronic device (e.g., a smartphone, a tablet computer, an IoT device, an autonomous vehicle, a robot, etc.) capable of wireless communication. The UE 152 includes example network credentials 154 and example eSIM login credentials 156. In some examples, the network credentials 154 can correspond to the first access credentials 132 of FIG. 1A (e.g., Wi-Fi login credentials) or any other type of network credentials. In some examples, the eSIM login credentials 156 can correspond to the second access credentials 134 of FIG. 1A. The datastore 162 includes example login keys 164. In some examples, the login keys 164 can correspond to the Wi-Fi login keys 136 of FIG. 1A and/or the 5G login keys 138 of FIG. 1A. In some examples, the MWAC 160 can correspond to the MWAC 108 of FIG. 1A.

In some examples, the first network 166 is a cellular network, such as a fourth generation (4G) long term evolution (LTE), 5G, 6G, etc., network. In some examples, the second network 168 is a Wi-Fi network. In some examples, the third network 170 is a wired network, which can be implemented by Ethernet. Additionally and/or alternatively, the first network 166, the second network 168, and/or the third network 170 may be any other type of network, such as a Bluetooth network, a satellite network, a process control network, etc.

In some examples, the MWAC 160 can facilitate communication between the UE 152 and a plurality of different networks, such as the networks 166, 168, 170 of FIG. 1B. For example, the UE 152 can transmit wireless data in any data format or based on any type of wireless communication protocol (e.g., Bluetooth, Wi-Fi, 4G LTE, 5G, 6G, etc.) to the wireless access point 158. The wireless access point 158 can output the wireless data to the MWAC 160. The MWAC 160 can transmit the wireless data to the first network 166, the second network 168, and/or the third network 170 using an applicable data format or communication protocol. For example, the MWAC 160 can transmit wireless data to an electronic device via the first network 166 using a cellular network protocol, such as 4G LTE, 5G, 6G, etc. In some examples, the MWAC 160 can transmit wireless data to an electronic device via the second network 168 using Wi-Fi. In some examples, the MWAC 160 can transmit wired data to an electronic device via the third network 170 using Ethernet.

Advantageously, the MWAC 160 can enable the UE 152 to be in communication with one(s) of the networks 166, 168, 170 using any type of data format and/or communication protocol (wired or wireless). Advantageously, the MWAC 160 can enable the UE 152 to be in communication with one(s) of the networks 166, 168, 170 with the same network credentials 154. For example, the UE 152 can transmit wireless data to the first network 166 by using the network credentials 154, the second network 168 by using the network credentials 154, and/or the third network 170 by using the network credentials 154. Additionally, the MWAC 160 advantageously can enable the UE 152 to be in communication with one(s) of the networks 166, 168, 170 using the same login keys 164. For example, the datastore 162 can store a set of the login keys 164 per UE. For example, the login keys 164 of the illustrated example can be associated with the UE 152 and a different set of the login keys 164 can be associated with a different UE. In some examples, the MWAC 160 can cause generation of the eSIM login credentials 156 based on the login keys 164. In some examples, the MWAC 160 can transmit data to and/or received data from one(s) of the networks 166, 168, 170 by using the login keys 164.

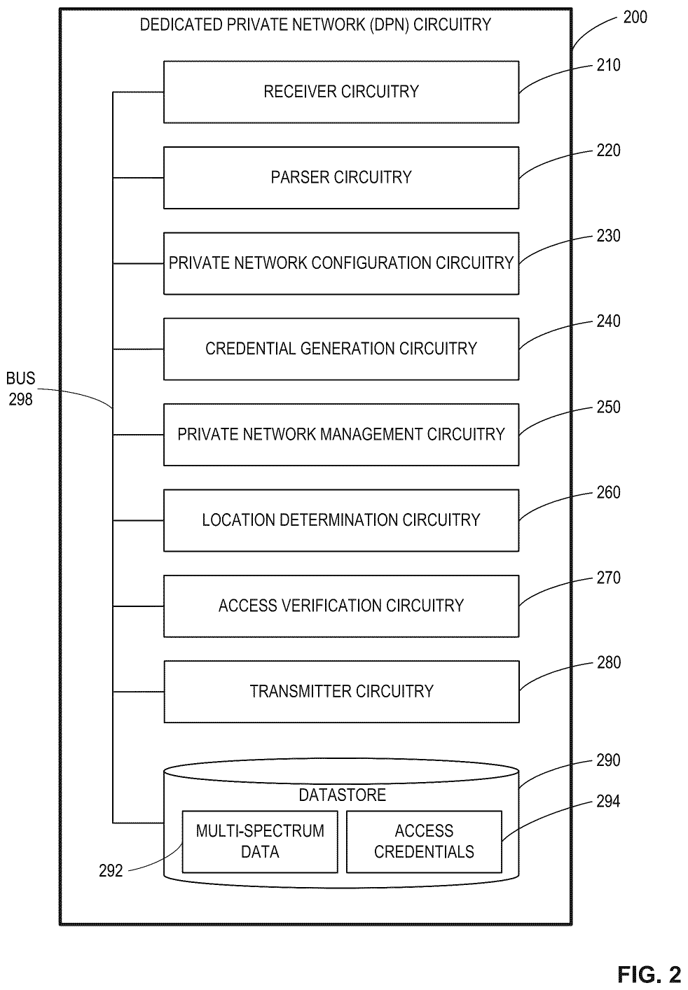

FIG. 2 is a block diagram of DPN circuitry 200 for device authentication in a dedicated private network. In some examples, the DPN 102 of FIG. 1A can be implemented and/or instantiated by the DPN circuitry 200 of FIG. 2. The DPN circuitry 200 of FIG. 2 may be instantiated (e.g., creating an instance of, bring into being for any length of time, materialize, implement, etc.) by processor circuitry such as a central processing unit executing instructions. Additionally or alternatively, the DPN circuitry 200 of FIG. 2 may be instantiated (e.g., creating an instance of, bring into being for any length of time, materialize, implement, etc.) by an ASIC or an FPGA structured to perform operations corresponding to the instructions. It should be understood that some or all of the DPN circuitry 200 of FIG. 2 may, thus, be instantiated at the same or different times. Some or all of the DPN circuitry 200 of FIG. 2 may be instantiated, for example, in one or more threads executing concurrently on hardware and/or in series on hardware. Moreover, in some examples, some or all of the DPN circuitry 200 of FIG. 2 may be implemented by microprocessor circuitry executing instructions to implement one or more virtual machines and/or containers.

In the illustrated example of FIG. 2, the DPN circuitry 200 includes example receiver circuitry 210, example parser circuitry 220, example private network configuration circuitry 230, example credential generation circuitry 240, example private network management circuitry 250, example location determination circuitry 260, example access verification circuitry 270, example transmitter circuitry 280, an example datastore 290, and an example bus 298. In this example, the datastore 290 includes example multi-spectrum data 292 and example access credentials 294. In examples disclosed herein, the example receiver circuitry 210, the example parser circuitry 220, the example private network configuration circuitry 230, the example credential generation circuitry 240, the example private network management circuitry 250, the example location determination circuitry 260, the example access verification circuitry 270, the example transmitter circuitry 280, the example datastore 290, and the example bus 298 are implemented in a manner such that the number of computational cycles available to an application implemented on the DPN 200 is optimized (e.g., maximized).

In the illustrated example of FIG. 2, the receiver circuitry 210, the parser circuitry 220, the private network configuration circuitry 230, the credential generation circuitry 240, the private network management circuitry 250, the location determination circuitry 260, the access verification circuitry 270, the transmitter circuitry 280, and/or the datastore 290 is/are in communication with one(s) of each other via the bus 298. For example, the bus 298 may be implemented with at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCI-E) bus. Additionally or alternatively, the bus 298 may be implemented with any other type of computing or electrical bus.

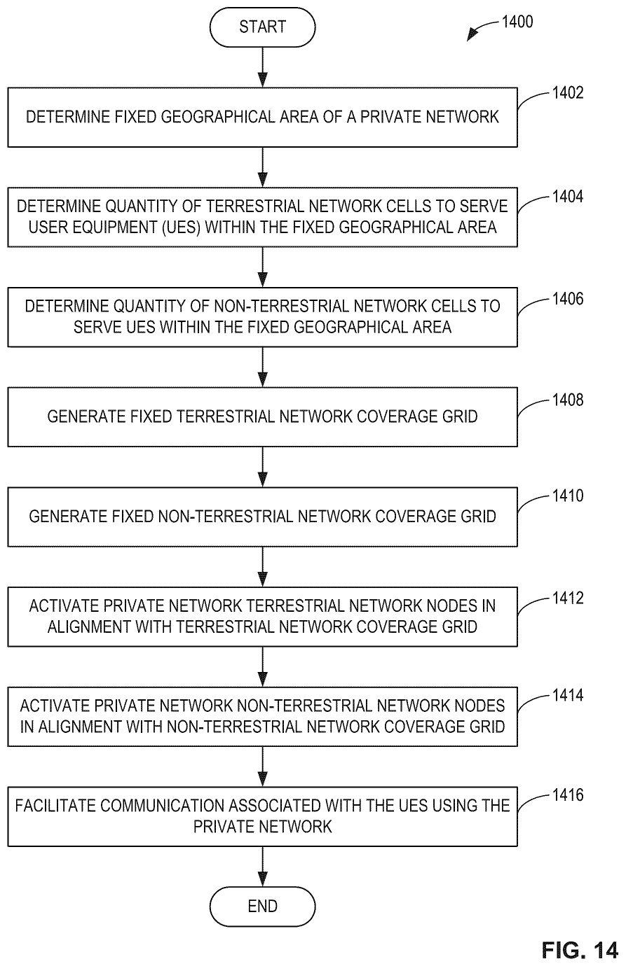

In the illustrated example of FIG. 2, the DPN circuitry 200 includes the receiver circuitry 210 to receive data from device(s), and, in some examples, store the received data as the multi-spectrum data 292. For example, the receiver circuitry 210 may receive data from the device 106 of FIG. 1A. In some examples, the receiver circuitry 210 may be implemented by hardware in accordance with any type of interface standard, such as an Ethernet interface, a universal serial bus (USB) interface, a Bluetooth® interface, a near field communication (NFC) interface, a PCI interface, a PCIe interface, a secure payment gateway (SPG) interface, a (global navigation satellite system) GNSS interface, a 4G/5G/6G interface, a CBRS (citizen broadband radio service) interface, a category 1 (CAT-1) interface, a category M (CAT-M) interface, a narrowband IoT (NB-IoT) interface, etc., and/or any combination thereof. In some examples, the receiver circuitry 210 may include one or more communication devices such as one or more receivers, one or more transceivers, one or more modems, one or more gateways (e.g., residential, commercial, or industrial gateways), one or more wireless access points, and/or one or more network interfaces to facilitate exchange of data with external machines (e.g., computing devices of any kind) by a network. In some examples, the receiver circuitry 210 may implement the communication by, for example, an Ethernet connection, a DSL connection, a telephone line connection, a coaxial cable system, a satellite system, a line-of-site wireless system, a cellular telephone system, an optical connection, etc., and/or any combination thereof. In some examples, the receiver circuitry 210 is instantiated by processor circuitry executing receiver instructions and/or configured to perform operations such as those represented by the flowcharts of FIGS. 14-18.

In some examples, the receiver circuitry 210, and/or, more generally, the DPN circuitry 200, executes and/or instantiates a programmable data collector (PDC). In some examples, the receiver circuitry 210 can initialize the PDC. For example, the PDC can be implemented by hardware, software, and/or firmware to access data (e.g., cellular data, Wi-Fi data, etc.) asynchronously or synchronously based on a policy (e.g., a location determination policy, a service level agreement (SLA), etc.). For example, the PDC can be initialized by being instantiated on hardware (e.g., by configuring an FPGA to implement the PDC), software (e.g., by configuring an application, a virtual machine, a container, etc., to implement the PDC), and/or firmware. In some examples, the receiver circuitry 210 configures the PDC based on a policy. For example, the receiver circuitry 210 can configure the PDC to access data at a specified time interval. In some examples, the parser circuitry 220 can configure the PDC to parse data, such as 5G L1 data (e.g., SRS data) substantially instantaneously with the receipt of the 5G L1 data by the receiver circuitry 210 based on an SLA. In some examples, the parser circuitry 220 can configure the PDC to parse 5G L1 data periodically (e.g., every minute, every hour, every day, etc.) based on an SLA, aperiodically based on the SLA, etc.

In the illustrated example of FIG. 2, the DPN circuitry 200 includes the parser circuitry 220 to extract portion(s) of data received by the receiver circuitry 210. In some examples, the parser circuitry 220 may extract portion(s) from data such as cell site or cell tower data, location data (e.g., coordinate data, such as x (horizontal), y (vertical), and/or z (altitude) coordinate data), registration data (e.g., cellular registration data), sensor data (e.g., motion measurements, pressure measurements, speed measurements, temperature measurements, etc.), image data (e.g., camera data, video data, pixel data, etc.), device identifiers (e.g., vendor identifiers, manufacturer identifiers, device name identifiers, etc.), headers (e.g., Internet Protocol (IP) addresses and/or ports, media access control (MAC) addresses and/or ports, etc.), payloads (e.g., protocol data units (PDUs), hypertext transfer protocol (HTTP) payloads, etc.), cellular data (e.g., OSI Layer 1 (L1) data, OSI Layer 2 (L2) data, User Datagram Protocol/Internet Protocol (UDP/IP) data, General Packet Radio Services (GPRS) tunnel protocol user plane (GTP-U) data, etc.), etc., and/or any combination thereof. In some examples, the parser circuitry 220 may store one(s) of the extracted portion(s) in the datastore 290 as the multi-spectrum data 292.

In some examples, the parser circuitry 220 implements hardware queue management circuitry to extract data from the receiver circuitry 210. In some examples, the parser circuitry 220 generates queue events (e.g., data queue events). In some such examples, the queue events may be implemented by an array of data. Alternatively, the queue events may have any other data structure. For example, the parser circuitry 220 may generate a first queue event, which may include a data pointer referencing data stored in memory, a priority (e.g., a value indicative of the priority) of the data, etc. In some examples, the events may be representative of, indicative of, and/or otherwise representative of workload(s) to be facilitated by the hardware queue management circuitry, which may be implemented by the parser circuitry 220. For example, the queue event may be an indication of data to be enqueued to the hardware queue management circuitry.

In some examples, a queue event, such as the first queue event, may be implemented by an interrupt (e.g., a hardware, software, and/or firmware interrupt) that, when generated and/or otherwise invoked, may indicate (e.g., an indication) to the hardware queue management circuitry that there is/are workload(s) associated with the multi-spectrum data 292 to process. In some examples, the hardware queue management circuitry may enqueue the queue event by enqueueing the data pointer, the priority, etc., into first hardware queue(s) included in and/or otherwise implemented by the hardware queue management circuitry. In some examples, the hardware queue management circuitry may dequeue the queue event by dequeuing the data pointer, the priority, etc., into second hardware queue(s) (e.g., consumer queue(s)) that may be accessed by consumer or worker processor cores for subsequent processing) that is/are included in and/or otherwise implemented by the hardware queue management circuitry.

In some examples, a worker processor core may write data to the queue event. For example, in response to dequeuing the queue event from the hardware queue management circuitry and completing a computation operation on the data (e.g., extracting data portion(s) of interest from the data) referenced by the data pointer, the worker processor core may write a completion bit, byte, etc., into the queue event, and enqueue the queue event back to the hardware queue management circuitry. In some such examples, the hardware queue management circuitry may determine that the computation operation has been completed by identifying the completion bit, byte, etc., in the queue event. In some examples, the parser circuitry 220 is instantiated by processor circuitry executing parser instructions and/or configured to perform operations such as those represented by the flowcharts of FIGS. 14-18.

In the illustrated example of FIG. 2, the DPN circuitry 200 includes the private network configuration circuitry 230 to instantiate and/or configure a DPN, such as the DPN 102 of FIG. 1A. For example, the private network configuration circuitry 230 can configure a quantity of private network cells to service a quantity of UEs, such as the device 106. In some examples, the private network configuration circuitry 230 can configure the device 106 to transmit cellular data (e.g., sounding reference signal (SRS) data) on a synchronous and/or asynchronous basis. In some examples, the private network configuration circuitry 230 can configure the device 106 to transmit cellular data (e.g., SRS data) on a periodic and/or aperiodic basis. In some examples, the private network configuration circuitry 230 can configure a rate at which the device 106 is to transmit cellular data. In some examples, the private network configuration circuitry 230 can configure a rate at which the parser circuitry 220 is to extract and/or store portion(s) of the cellular data. In some examples, the private network configuration circuitry 230 is instantiated by processor circuitry executing private network configuration instructions and/or configured to perform operations such as those represented by the flowcharts of FIGS. 14-18.

In the illustrated example of FIG. 2, the DPN circuitry 200 includes the credential generation circuitry 240 to generate access credentials, login credentials, keys (e.g., access keys, login keys, cryptographic keys, etc.), etc., to access a DPN, such as the DPN 102 of FIG. 1A. In some examples, the credential generation circuitry 240 generates the Wi-Fi login keys 136. For example, the credential generation circuitry 240 can generate the Wi-Fi login keys 136 based on a policy (e.g., an SLA policy, an IT policy, an enterprise security policy, etc.). In some examples, the credential generation circuitry 240 can generate the 5G login keys 138. For example, the credential generation circuitry 240 can generate the 5G login keys 138 based on the Wi-Fi login keys 136, or portion(s) thereof. For example, the credential generation circuitry 240 can provide the Wi-Fi login keys 136, or portion(s) thereof, as input(s) to a hash algorithm or function to generate output(s), which can include the 5G login keys 138. In some examples, the credential generation circuitry 240 can store at least one of the Wi-Fi login keys 136 or the 5G login keys 138 in the datastore 290 as the access credentials 294. In some examples, the credential generation circuitry 240 is instantiated by processor circuitry executing credential generation instructions and/or configured to perform operations such as those represented by the flowcharts of FIGS. 14-18.

In the illustrated example of FIG. 2, the DPN circuitry 200 includes the private network management circuitry 250 to handle requests for data associated with a DPN, such as the DPN 102 of FIG. 1A. In some examples, the private network management circuitry 250 can process a request for a location of the device 106. In some examples, the private network management circuitry 250 can obtain a determination of the location of the device 106 and provide the location of the device 106 to an application, a service, etc. In some examples, the private network management circuitry 250 is instantiated by processor circuitry executing private network management instructions and/or configured to perform operations such as those represented by the flowcharts of FIGS. 14-18.

In the illustrated example of FIG. 2, the DPN circuitry 200 includes the location determination circuitry 260 to determine a direction and/or a location of UEs, such as the device 106. In some examples, the location determination circuitry 260 can determine a motion vector including the direction, a speed, etc., of the device 106. In some examples, the location determination circuitry 260 can determine the direction, and/or, more generally, the motion vector, of the device 106 based on the multi-spectrum data 292. For example, the location determination circuitry 260 can determine the direction, and/or, more generally, the motion vector, based on time-of-arrival (TOA) measurements, angle-of-arrival (AOA) measurements, time-difference-of-arrival (TDOA) measurements, multi-cell round trip time (RTT) measurements, etc., associated with the device 106. In some examples, the location determination circuitry 260 can store the direction(s), and/or, more generally, the motion vector(s), in the datastore 290 as the multi-spectrum data 292.

In some examples, the location determination circuitry 260 can determine a location of the device 106 based on TOA techniques as described herein. For example, the location determination circuitry 260 can determine a TOA associated with data, or portion(s) thereof, received at a base station, such as the gNB 118 of the DPN 102. As used herein, time-of-arrival or TOA refers to the time instant (e.g., the absolute time instant) when a signal (e.g., a radio signal, an electromagnetic signal, an acoustic signal, an optical signal etc.) emanating from a transmitter (e.g., transmitter circuitry) reaches a remote receiver (e.g., remote receiver circuitry). For example, the location determination circuitry 260 can determine a TOA of portion(s) of the multi-spectrum data 292. In some examples, the location determination circuitry 260 can determine the TOA based on the time span that has elapsed since the time of transmission (TOT). In some such examples, the time span is referred to as the time of flight (TOF). For example, the location determination circuitry 260 can determine the TOA of data received by the receiver circuitry 210 based on a first time that a signal was sent from a device, a second time that the signal is received at the receiver circuitry 210, and the speed at which the signal travels (e.g., the speed of light). In some examples, the location determination circuitry 260 can store the TOA data, measurements, etc., in the datastore 290 as the multi-spectrum data 292.

In some examples, the location determination circuitry 260 can determine a location of the device 106 based on angle-of-arrival (AOA) techniques as described herein. For example, location determination circuitry 260 can determine an AOA associated with data, or portion(s) thereof, received at a base station, such as the gNB 118 of the DPN 102. As used herein, the angle-of-arrival or AOA of a signal is the direction from which the signal (e.g., a radio signal, an electromagnetic signal, an acoustic signal, an optical signal, etc.) is received. In some examples, the location determination circuitry 260 can determine the AOA of a signal based on a determination of the direction of propagation of the signal incident on a sensing array (e.g., an antenna array). In some examples, the location determination circuitry 260 can determine the AOA of a signal based on a signal strength (e.g., a maximum signal strength) during antenna rotation. In some examples, the location determination circuitry 260 can determine the AOA of a signal based on a time-difference-of-arrival (TDOA) between individual elements of a sensing array (e.g., an antenna array). In some examples, the location determination circuitry 260 can measure the difference in received phase at each element in the sensing array, and convert the delay of arrival at each element to an AOA measurement. In some examples, the location determination circuitry 260 can store the AOA data, measurements, etc., in the datastore 290 as the multi-spectrum data 292.

In some examples, the location determination circuitry 260 can determine a location (e.g., x, y, and/or z-coordinates in a geometric plane) of an object or device, such as the device 106. In some examples, the location determination circuitry 260 can determine the position of the device 106 based on the multi-spectrum data 292. For example, the location determination circuitry 260 can determine a position (e.g., a position vector) of a device, such as the device 106, based on at least one of AOA, TOA, or TDOA data associated with the device 106. In some examples, the location determination circuitry 260 is instantiated by processor circuitry executing location determination instructions and/or configured to perform operations such as those represented by the flowcharts of FIGS. 14-18.

In the illustrated example of FIG. 2, the DPN circuitry 200 includes the access verification circuitry 270 to grant or deny (e.g., permit or prevent) requests for access to the DPN 102 by a device, such as the device 106 of FIG. 1A. In some examples, the access verification circuitry 270 can grant access to the device 106 to the DPN 102 after a determination that location data of the second access credentials 134 (e.g., eSIM login credentials) is associated with location data of the DPN 102. In some examples, the access verification circuitry 270 can deny (e.g., prevent) access to the device 106 to the DPN 102 after a determination that location data of the second access credentials 134 (e.g., eSIM login credentials) is not associated with location data of the DPN 102. In some examples, the access verification circuitry 270 is instantiated by processor circuitry executing access verification instructions and/or configured to perform operations such as those represented by the flowcharts of FIGS. 14-18.

In the illustrated example of FIG. 2, the DPN circuitry 200 includes the transmitter circuitry 280 to transmit data to device(s). For example, the transmitter circuitry 280 may transmit data to the device 106. In some examples, the transmitter circuitry 280 is instantiated by processor circuitry executing transmitter instructions and/or configured to perform operations such as those represented by the flowcharts of FIGS. 14-18.

In some examples, the transmitter circuitry 280 may be implemented by hardware in accordance with any type of interface standard, such as an Ethernet interface, a USB interface, a Bluetooth® interface, an NFC interface, a PCI interface, a PCIe interface, an SPG interface, a GNSS interface, a 4G/5G/6G interface, a CBRS interface, a CAT-1 interface, a CAT-M interface, an NB-IoT interface, etc., and/or any combination thereof. In some examples, the transmitter circuitry 280 may include one or more communication devices such as one or more transmitters, one or more transceivers, one or more modems, one or more gateways (e.g., residential, commercial, or industrial gateways), one or more wireless access points, and/or one or more network interfaces to facilitate exchange of data with external machines (e.g., computing devices of any kind) by a network. In some examples, the transmitter circuitry 280 may implement the communication by, for example, an Ethernet connection, a DSL connection, a telephone line connection, a coaxial cable system, a satellite system, a line-of-site wireless system, a cellular telephone system, an optical connection, etc., and/or any combination thereof.

In the illustrated example of FIG. 2, the DPN circuitry 200 includes the datastore 290 to record data (e.g., the multi-spectrum data 292, the access credentials 294, etc.). The datastore 290 of this example may be implemented by a volatile memory and/or a non-volatile memory (e.g., flash memory). The datastore 290 may additionally or alternatively be implemented by one or more double data rate (DDR) memories, such as DDR, DDR2, DDR3, DDR4, mobile double data rate (mDDR), etc. The datastore 290 may additionally or alternatively be implemented by one or more mass storage devices such as hard disk drive(s) (HDD(s)), compact disk (CD) drive(s), digital versatile disk (DVD) drive(s), solid-state disk (SSD) drive(s), etc. While in the illustrated example the datastore 290 is illustrated as a single datastore, the datastore 290 may be implemented by any number and/or type(s) of datastores. Furthermore, the data stored in the datastore 290 may be in any data format such as, for example, binary data, comma delimited data, tab delimited data, structured query language (SQL) structures, an executable (e.g., an executable binary, an executable file, etc.), etc. In some examples, the datastore 290 is instantiated by processor circuitry executing datastore instructions and/or configured to perform operations such as those represented by the flowcharts of FIGS. 14-18.

In some examples, the multi-spectrum data 292 may include data received by the receiver circuitry 210. For example, the multi-spectrum data 292 may receive data from the device 106, a satellite, a Bluetooth device, a Wi-Fi device, a cellular device, etc. In some examples, the multi-spectrum data 292 may include GPS data, 4G LTE/5G/6G data, direction data, and/or speed data associated with the device 106. In some examples, the multi-spectrum data 292 can include device identification data, TOA data, AOA data, TDOA data, event data, direction data, location data, etc., and/or any combination(s) thereof.

While an example manner of implementing the DPN 102 of FIG. 1A is illustrated in FIG. 2, one or more of the elements, processes, and/or devices illustrated in FIG. 2 may be combined, divided, re-arranged, omitted, eliminated, and/or implemented in any other way. Further, the example receiver circuitry 210, the example parser circuitry 220, the example private network configuration circuitry 230, the example credential generation circuitry 240, the example private network management circuitry 250, the example location determination circuitry 260, the example access verification circuitry 270, the example transmitter circuitry 280, and/or the example datastore 290, and/or, more generally, the example DPN 102 of FIG. 1A, may be implemented by hardware alone or by hardware in combination with software and/or firmware. Thus, for example, any of the example receiver circuitry 210, the example parser circuitry 220, the example private network configuration circuitry 230, the example credential generation circuitry 240, the example private network management circuitry 250, the example location determination circuitry 260, the example access verification circuitry 270, the example transmitter circuitry 280, and/or the example datastore 290, and/or, more generally, the example DPN 102, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example DPN 102 of FIG. 1A may include one or more elements, processes, and/or devices in addition to, or instead of, those illustrated in FIG. 2, and/or may include more than one of any or all of the illustrated elements, processes and devices.

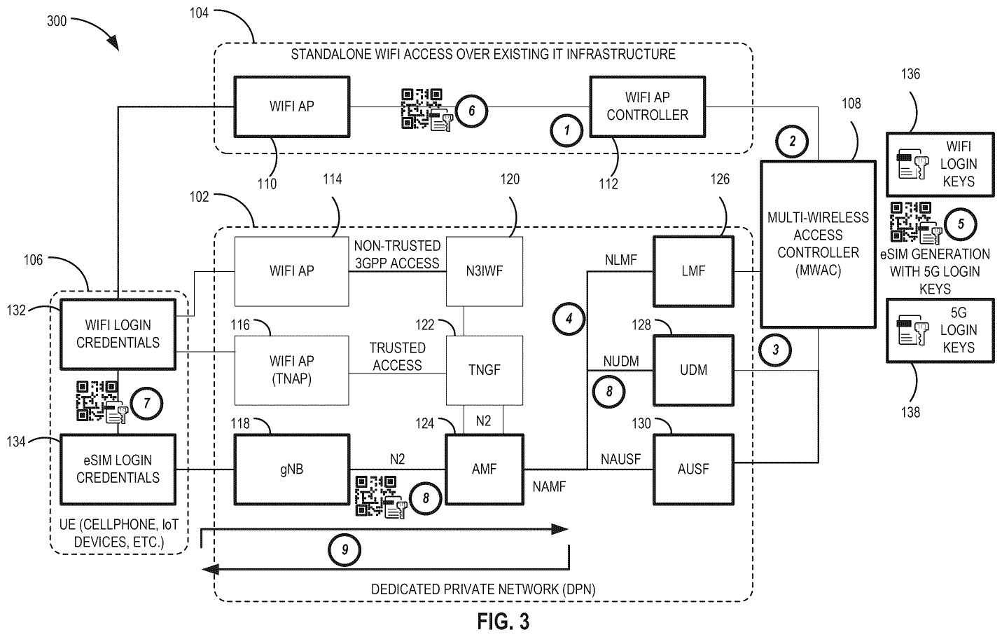

FIG. 3 is a first example workflow 300 to register the example device 106 illustrated in FIG. 1A with the example DPN 102 of FIG. 1A using the first example Wi-Fi infrastructure 104 illustrated in FIG. 1A. In the example of FIG. 3, the first Wi-Fi infrastructure 104 is an established Wi-Fi network infrastructure that is not included in the DPN 102. In the example of FIG. 3, at a first operation of the first workflow 300, the device 106 connects to the first Wi-Fi infrastructure 104 via the first Wi-Fi AP 110. In the example of FIG. 3, at the first operation of the first workflow 300, the Wi-Fi AP controller 112 generates the Wi-Fi login keys 136 with which the device 106 is to use to log into a Wi-Fi network (e.g., a Wi-Fi network provided by the first Wi-Fi AP 110). In some examples, the Wi-Fi login keys 136 may also be generated offline and passed to device 106 through other offline techniques.

In the illustrated example of FIG. 3, at a second operation of the first workflow 300, the Wi-Fi login keys 136 are passed to the MWAC 108 to generate the 5G login keys 138. For example, at the second operation of the first workflow 300, the Wi-Fi login keys 136 are passed to the MWAC 108 to generate the 5G login keys 138 based on whether the Wi-Fi login keys 136 correspond to access credentials for a Wi-Fi network provided by the first Wi-Fi AP 110. In some examples, the Wi-Fi login keys 136 are passed to the MWAC 108 to generate the 5G login keys 138 if the Wi-Fi login keys 136 match, satisfy, and/or otherwise correspond to access credentials for the Wi-Fi network provided by the first Wi-Fi AP 110. At a third example operation of the first workflow 300, the 5G login keys 138 are passed to the UDM 128, the AUSF 130, and the LMF 126 of the 5G network control plane of the DPN 102 for registration. In the example of FIG. 3, at a fourth operation of the first workflow 300, the AMF 124 informs the LMF 126 to set periodic/aperiodic location verification of the device 106 for specific measurement periodicities.

In the illustrated example of FIG. 3, at a fifth operation of the first workflow 300, the MWAC 108 uses the 5G login keys 138 to generate a quick response (QR) code to configure the eSIM of the device 106. Alternatively, any other type of code may be used. In the example of FIG. 3, at a sixth operation of the first workflow 300, the eSIM QR code is provisioned over the established Wi-Fi network data plane to the device 106 through the first Wi-Fi AP 110 and the Wi-Fi AP controller 112. For example, at the sixth operation of the first workflow 300, the Wi-Fi AP controller 112 causes transmission of the eSIM QR code to the device 106 via the first Wi-Fi AP 110.

In the illustrated example of FIG. 3, at a seventh operation of the first workflow 300, the device 106 executes and/or otherwise utilizes the eSIM QR code, which contains the 5G login keys 138. For example, the device 106 can execute and/or otherwise run a script (e.g., an automatic script) to register the eSIM with the device 106. In the example of FIG. 3, at an eighth operation of the first workflow 300, the 5G login keys 138 are cross referenced with the UDM 128, the AUSF 130, and the LMF 126 through the AMF 124 over the 5G Core Service-Based Architecture (SBA) in the DPN 102. For example, at the eighth operation of the first workflow 300, the device 106 causes transmission of the eSIM to the AMF 124 via the gNodeB 118. Additionally, for example, at the eighth operation of the first workflow 300, the AMF 124 communicates the eSIM and/or data embedded in the eSIM to the UDM 128, the AUSF 130, and the LMF 126 which verify whether location data embedded in the eSIM corresponds to location data embedded in the 5G login keys 138. For example, the location data embedded in the 5G login keys 138 is indicative of a geographic area of the DPN 102.

In the illustrated example of FIG. 3, upon successful verification, the DPN 102 grants the device 106 5G access into the DPN 102. For example, upon successful verification, the MWAC 108 grants the device 106 5G access to the DPN 102. In the example of FIG. 3, at a ninth operation of the first workflow 300, location monitoring can occur per a policy (e.g., an enterprise DPN policy) via periodic/aperiodic LMF Triggered Device/UE Location verification. For example, at the ninth operation of the first workflow 300, the LMF 126 can verify that the location data of the device 106 corresponds to a fixed or known geographical area of the DPN 102. The example of FIG. 3 illustrates a workflow to register the device 106 with a cellular network of the DPN 102 using the first Wi-Fi infrastructure 104. Additionally or alternatively, the workflow of FIG. 3 can be reversed such that the device 106 is registered with a Wi-Fi network of the DPN 102 using the cellular network. For example, the MWAC 108 can program a Wi-Fi certification associated with the device 106 based on the 5G login keys 138 by utilizing a QR code provisioned to the device 106 via the cellular network of the DPN 102.

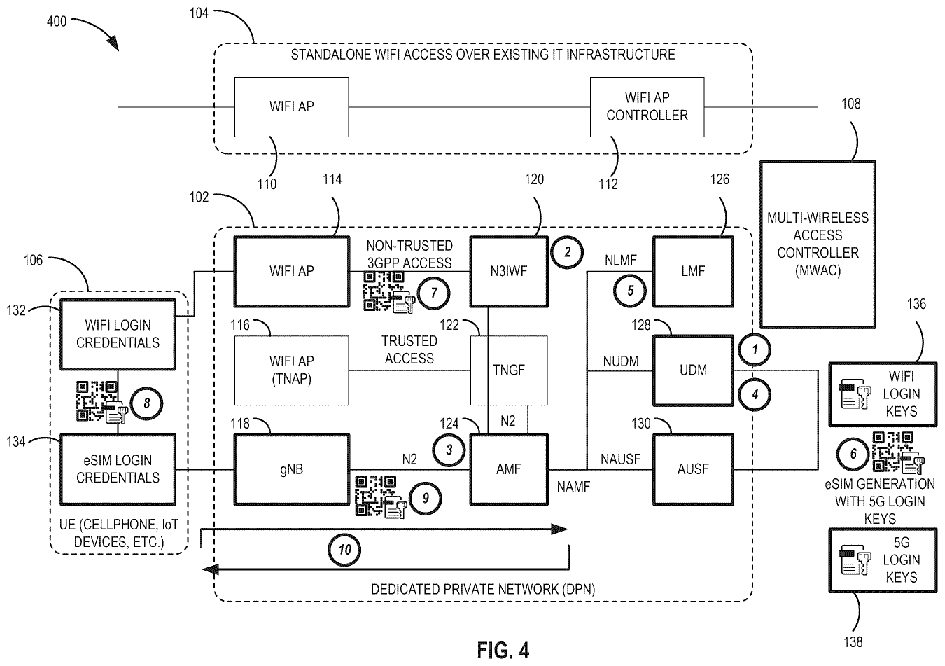

FIG. 4 is a second example workflow 400 to register the example device 106 of FIG. 1A with the example DPN 102 of FIG. 1A using the example N3IWF 120 illustrated in FIG. 1A. In the example of FIG. 4, at a first operation of the second workflow 400, the MWAC 108 generates the Wi-Fi login keys 136. For example, at the first operation of the second workflow 400, the MWAC 108 generates the Wi-Fi login keys 136 based on a policy (e.g., an SLA policy, an IT policy, an enterprise security policy, etc.). Additionally, at the first operation of the second workflow 400, the MWAC 108 communicates the Wi-Fi login keys 136 to the UDM 128 and the AUSF 130 of the network control plane of the DPN 102 for registration.

In the illustrated example of FIG. 4, at a second operation of the second workflow 400, the device 106 connects to the second Wi-Fi AP 114. For example, at the second operation of the second workflow 400, the second Wi-Fi AP 114 determines whether to permit the device 106 to connect to a Wi-Fi network provided by the second Wi-Fi AP 114 based on whether credentials provided by the device 106 correspond to access credentials for the Wi-Fi network provided by the second Wi-Fi AP 114. Additionally, at the second operation of the second workflow 400, based on the device 106 connecting to the second Wi-Fi AP 114, the second Wi-Fi AP 114 selects the N3IWF 120 as the PLMN for the second Wi-Fi AP 114. In this manner, at the second operation of the second workflow 400, the second Wi-Fi AP 114 obtains an Internet Protocol (IP) address and establishes an Internet Protocol Security (IPSec) security association (SA) through the non-trusted 3GPP access. In the example of FIG. 4, at a third operation of the second workflow 400, after the N3IWF 120 selects the AMF 124, the AMF 124 authenticates the device 106 by invoking the AUSF 130, which chooses the UDM 128 to obtain authentication data and executes Extensible Authentication Protocol Authentication and Key Agreement (EAP-AKA) or 5G-AKA authentication. After a successful authentication, the AUSF 130 communicates a Security Anchor Function (SEAF) key to the AMF 124. As such, a Wi-Fi connection over the N3IWF 120 is now established between the second Wi-Fi AP 114 and the device 106.

In the illustrated example of FIG. 4, at a fourth operation of the second workflow 400, the MWAC 108 utilizes the Wi-Fi login keys 136 to generate the 5G login keys 138 and communicates the 5G login keys 138 to the UDM 128 and the AUSF 130 of the network control plane of the DPN 102 for registration. In the example of FIG. 4, at a fifth operation of the second workflow 400, the AMF 124 informs the LMF 126 to set periodic/aperiodic location verification of the device for specific (or specified) verifications and measurement periodicities. In the example of FIG. 4, at a sixth operation of the second workflow 400, the MWAC 108 utilizes the 5G login keys 138 to generate the eSIM, which can be in the form of a QR code. Alternatively, any other type of code may be used.

In the illustrated example of FIG. 4, at a seventh operation of the second workflow 400, the eSIM QR code is provisioned over the established Wi-Fi network data plane to the device 106 through the second Wi-Fi AP 114 and the N3IWF 120. For example, at the seventh operation of the second workflow 400, the N3IWF 120 causes transmission of the eSIM QR code to the device 106 via the second Wi-Fi AP 114. In the example of FIG. 4, at an eighth operation of the second workflow 400, the device 106 uses the eSIM QR code, which contains the 5G Login Keys 138. For example, at the eighth operation of the second workflow 400, the device 106 runs auto-script(s) to register the eSIM with the device 106.

In the illustrated example of FIG. 4, at a ninth operation of the second workflow 400, the 5G login keys 138 are cross referenced with the UDM 128, the AUSF 130, and the LMF 126 through the AMF 124 over 5G Core SBA of the DPN 102. For example, at the ninth operation of the second workflow 400, the device 106 causes transmission of the eSIM to the AMF 124 via the gNodeB 118. Additionally, for example, at the ninth operation of the second workflow 400, the AMF 124 communicates the eSIM and/or data embedded in the eSIM to the UDM 128, the AUSF 130, and the LMF 126 which verify whether location data embedded in the eSIM corresponds to location data embedded in the 5G login keys 138. For example, the location data embedded in the 5G login keys 138 is indicative of a geographic area of the DPN 102.

In the illustrated example of FIG. 4, upon successful verification, the device 106 is granted 5G access into the DPN 102. For example, upon successful verification, the MWAC 108 grants the device 106 5G access to the DPN 102. In the example of FIG. 4, at a tenth operation of the second workflow 400, location monitoring is to occur per a policy (e.g., an enterprise DPN policy) specifically via periodic/aperiodic LMF Triggered UE/Device Location verification. For example, at the tenth operation of the second workflow 400, the LMF 126 can verify that the location data of the device 106 corresponds to a fixed or known geographical area of the DPN 102. The example of FIG. 4 illustrates a workflow to register the device 106 with a cellular network of the DPN 102 using the N3IWF 120. Additionally or alternatively, the workflow of FIG. 4 can be reversed such that the device 106 is registered with a Wi-Fi network of the DPN 102 using the cellular network. For example, the MWAC 108 can program a Wi-Fi certification associated with the device 106 based on the 5G login keys 138 by utilizing a QR code provisioned to the device 106 via the cellular network of the DPN 102.

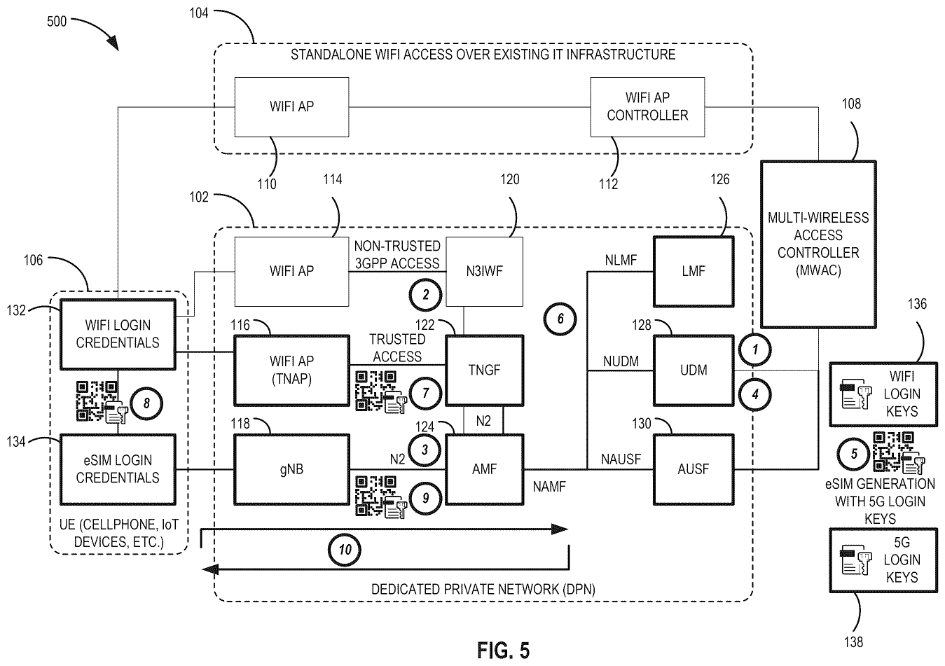

FIG. 5 is a third example workflow 500 to register the example device 106 of FIG. 1A with the example DPN 102 of FIG. 1A using Trusted 3GPP Access over the third Wi-Fi AP 116 and the TNGF 122 of FIG. 1A. In the example of FIG. 5, at a first operation of the third workflow 500, the MWAC 108 generates the Wi-Fi login keys 136. Additionally, at the first operation of the third workflow 500, the MWAC 108 communicates the Wi-Fi login keys 136 to the UDM 128 and the AUSF 130 of the network control plane of the DPN 102 for registration. In the example of FIG. 5, at a second operation of the third workflow 500, the device 106 connects to the third Wi-Fi AP 116. For example, at the second operation of the third workflow 500, the third Wi-Fi AP 116 determines whether to permit the device 106 to connect to a Wi-Fi network provided by the third Wi-Fi AP 116 based on whether credentials provided by the device 106 correspond to access credentials for the Wi-Fi network provided by the third Wi-Fi AP 116. Additionally, at the second operation of the third workflow 500, based on the device 106 connecting to the third Wi-Fi AP 116, the third Wi-Fi AP 116 selects the TNGF 122 as the PLMN for the third Wi-Fi AP 116. In this manner, at the second operation of the third workflow 500, the third Wi-Fi Ap 116 obtains the IP address and establishes an IPSec SA through the trusted non-3GPP access.

In the illustrated example of FIG. 5, at a third operation of the third workflow 500, after the TNGF 122 selects the AMF 124, the AMF 124 authenticates the device 106 by invoking the AUSF 130, which chooses the UDM 128 to obtain authentication data and execute the EAP-AKA or 5G-AKA authentication. After a successful authentication, the AUSF 130 communicates a SEAF key to the AMF 124. As such, a Wi-Fi connection over the TNGF 122 is now established between the third Wi-Fi AP 116 and the device 106. In the example of FIG. 5, at a fourth operation of the third workflow 500, the MWAC 108 utilizes the Wi-Fi login keys 136 to generate the 5G login keys 138 and communicates the 5G login keys 138 to the UDM 128 and the AUSF 130 of the network control plane of the DPN 102 for registration.

In the illustrated example of FIG. 5, at a fifth operation of the third workflow 500, the MWAC 108 utilizes the 5G login keys 138 to generate the eSIM, which can be in the form of a QR code. Alternatively, any other type of code may be used. At a sixth operation of the third workflow 500, the AMF 124 informs the LMF 126 to set periodic/aperiodic location verification of the device for specific (or specified) verifications and measurement periodicities. In the example of FIG. 5, at a seventh operation of the third workflow 500, the eSIM QR code is provisioned over the established Wi-Fi network data plane to the UE through the third Wi-Fi AP 116 and the TNGF 122. For example, at the seventh operation of the third workflow 500, the TNGF 122 causes transmission of the eSIM QR code to the device 106 via the third Wi-Fi AP 116.

In the illustrated example of FIG. 5, at an eighth operation of the third workflow 500, the device 106 uses the eSIM QR code, which contains the 5G login keys 138. For example, the device 106 runs auto-script(s) to register the eSIM with the device 106. In the example of FIG. 5, at a ninth operation of the third workflow 500, the 5G login keys 138 are cross referenced with the UDM 128, the AUSF 130, and the LMF 126 through the AMF 124 over the 5G Core SBA in the DPN 102. For example, at the ninth operation of the third workflow 500, the device 106 causes transmission of the eSIM to the AMF 124 via the gNodeB 118. Additionally, for example, at the ninth operation of the third workflow 500, the AMF 124 communicates the eSIM and/or data embedded in the eSIM to the UDM 128, the AUSF 130, and the LMF 126 which verify whether location data embedded in the eSIM corresponds to location data embedded in the 5G login keys 138. For example, the location data embedded in the 5G login keys 138 is indicative of a geographic area of the DPN 102.

In the illustrated example of FIG. 5, upon successful verification, the device 106 is granted 5G access into the DPN 102. For example, upon successful verification, the MWAC 108 grants the device 106 5G access to the DPN 102. In the example of FIG. 5, at a tenth operation of the third workflow 500, location monitoring is to occur per a policy (e.g., an enterprise DPN policy) specifically via periodic/aperiodic LMF Triggered UE/Device Location verification. For example, at the tenth operation of the third workflow 500, the LMF 126 can verify that the location data of the device 106 corresponds to a fixed or known geographical area of the DPN 102. The example of FIG. 5 illustrates a workflow to register the device 106 with a cellular network of the DPN 102 using Trusted 3GPP Access over the third Wi-Fi AP 116 and the TNGF 122. Additionally or alternatively, the workflow of FIG. 5 can be reversed such that the device 106 is registered with a Wi-Fi network of the DPN 102 using the cellular network. For example, the MWAC 108 can program a Wi-Fi certification associated with the device 106 based on the 5G login keys 138 by utilizing a QR code provisioned to the device 106 via the cellular network of the DPN 102.

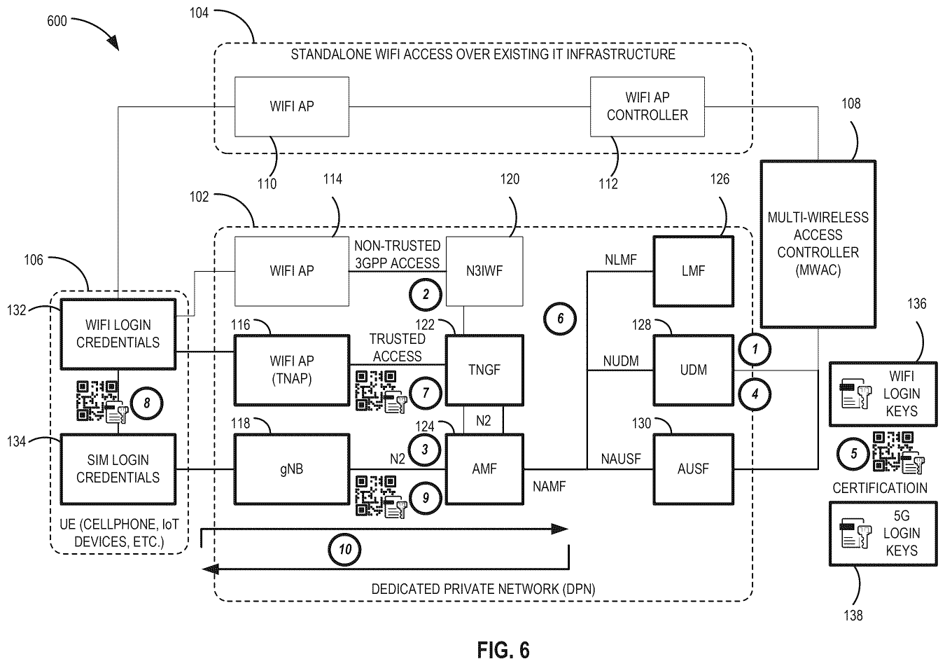

FIG. 6 is a fourth example workflow 600 to register the example device 106 of FIG. 1A with the example DPN 102 of FIG. 1A using a hardcoded identifier of a device that has been pre-registered with the DPN 102 of FIG. 1A. For example, in FIG. 6, the device 106 includes memory that has been burned with an identifier (e.g., a unique non-programmable identifier such as a serial number) and pre-registered with the DPN 102. In the example of FIG. 6, at a first operation of the fourth workflow 600, the MWAC 108 generates the Wi-Fi login keys 136. Additionally, at the first operation of the fourth workflow 600, the MWAC 108 communicates the Wi-Fi login keys 136 to the UDM 128 and the AUSF 130 of the network control plane of the DPN 102 for registration.

In the illustrated example of FIG. 6, at a second operation of the fourth workflow 600, the device 106 connects to the third Wi-Fi AP 116. For example, at the second operation of the fourth workflow 600, the third Wi-Fi AP 116 determines whether to permit the device 106 to connect to a Wi-Fi network provided by the third Wi-Fi AP 116 based on whether credentials provided by the device 106 correspond to access credentials for the Wi-Fi network provided by the third Wi-Fi AP 116. Additionally, at the second operation of the fourth workflow 600, based on the device 106 connecting to the third Wi-Fi AP 116, the third Wi-Fi AP 116 selects the TNGF 122 as the PLMN for the third Wi-Fi AP 116. In this manner, at the second operation of the fourth workflow 600, the third Wi-Fi AP 116 obtains the IP address and establishes an IPSec SA through the trusted non-3GPP access. In some examples, at the second operation of the fourth workflow 600, based on the device 106 connecting to the third Wi-Fi AP 116, the third Wi-Fi AP 116 selects the N3IWF 120 as the PLMN for the third Wi-Fi AP 116. In this manner, at the second operation of the fourth workflow 600, the third Wi-Fi AP 116 obtains an IP address and establishes an IPSec SA through the non-trusted 3GPP access. In the example of FIG. 6, at a third operation of the fourth workflow 600, after the TNGF 122 selects the AMF 124, the AMF 124 authenticates the device 106 by invoking the AUSF 130, which chooses the UDM 128 to obtain authentication data and execute the EAP-AKA or 5G-AKA authentication.

In the illustrated example of FIG. 6, after a successful authentication, the AUSF 130 communicates a SEAF key to the AMF 124. As such, a Wi-Fi connection over the TNGF 122 is now established between the third Wi-Fi AP 116 and the device 106. In the example of FIG. 6, at a fourth operation of the fourth workflow 600, the MWAC 108 utilizes the pre-registered identifier of the device 106 to generate the 5G login keys 138 and communicates the 5G login keys 138 to the UDM 128 and the AUSF 130 of the network control plane of the DPN 102 for registration. At a fifth operation of the fourth workflow 600, the MWAC 108 utilizes the 5G login keys 138 to generate a certification, which can be in the form of a QR code. Alternatively, any other type of code may be used.

In the illustrated example of FIG. 6, at a sixth operation of the fourth workflow 600, the AMF 124 informs the LMF 126 to set periodic/aperiodic location verification of the device for specific (or specified) verifications and measurement periodicities. In the example of FIG. 6, at a seventh operation of the fourth workflow 600, the certification QR code is provisioned over the established Wi-Fi network data plane to the UE through the third Wi-Fi AP 116 and the TNGF 122. For example, at the seventh operation of the third workflow 500, the TNGF 122 causes transmission of the certification QR code to the device 106 via the third Wi-Fi AP 116.

In the illustrated example of FIG. 6, at an eighth operation of the fourth workflow 600, the device 106 uses the certification QR code, which contains the 5G login keys 138. For example, the device 106 runs auto-script(s) to register the certification with the device 106. In the example of FIG. 6, at a ninth operation of the fourth workflow 600, the 5G login keys 138 are cross referenced with the UDM 128, the AUSF 130, and the LMF 126 through the AMF 124 over the 5G Core SBA in the DPN 102. For example, at the ninth operation of the fourth workflow 600, the device 106 causes transmission of the certification to the AMF 124 via the gNodeB 118. Additionally, for example, at the ninth operation of the fourth workflow 600, the AMF 124 communicates the certification and/or data embedded in the certification to the UDM 128, the AUSF 130, and the LMF 126 which verify whether location data embedded in the certification corresponds to location data embedded in the 5G login keys 138. For example, the location data embedded in the 5G login keys 138 is indicative of a geographic area of the DPN 102.

In the illustrated example of FIG. 6, upon successful verification, the device 106 is granted 5G access into the DPN 102. For example, upon successful verification, the MWAC 108 grants the device 106 5G access to the DPN 102. In the example of FIG. 6, at a tenth operation of the fourth workflow 600, location monitoring is to occur per a policy (e.g., an enterprise DPN policy) specifically via periodic/aperiodic LMF Triggered UE/Device Location verification. For example, at the tenth operation of the fourth workflow 600, the LMF 126 can verify that the location data of the device 106 corresponds to a fixed or known geographical area of the DPN 102. The example of FIG. 6 illustrates a workflow to register the device 106 with a cellular network of the DPN 102 using Trusted 3GPP Access over the third Wi-Fi AP 116 and the TNGF 122. Additionally or alternatively, the workflow of FIG. 6 can be reversed such that the device 106 is registered with a Wi-Fi network of the DPN 102 using the cellular network. For example, the MWAC 108 can program a Wi-Fi certification associated with the device 106 based on the 5G login keys 138 by utilizing a QR code provisioned to the device 106 via the cellular network of the DPN 102.

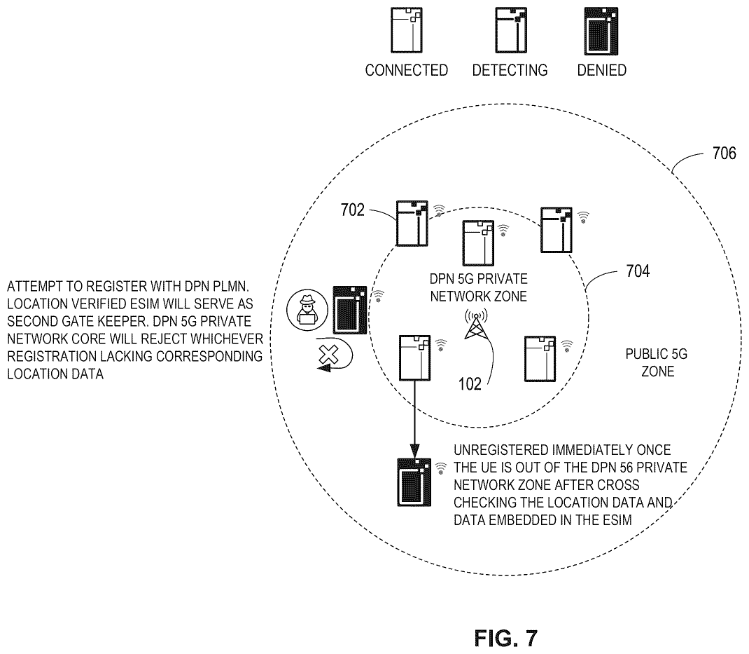

FIG. 7 depicts the example DPN 102 of FIG. 1A authenticating private network access requested by example devices 702. Further depicted in FIG. 7 is an example 5G private network zone 704, which is created and managed by the DPN 102 of FIG. 1A, and an example public 5G zone 706, which can be created and managed by a public network provider (e.g., a public telecommunications network provider). In example operation, the DPN 102 can determine whether one(s) of the devices 702 is/are within range of the 5G private network zone 704. If one(s) of the devices 702 is/are within range of the 5G private network zone 704, then the DPN 102 can validate the access credentials of the one(s) of the devices 702 and location data of eSIM(s) of the one(s) of the devices 702. Additionally and/or alternatively, the DPN 102 may validate the one(s) of the devices 702 based on network data (e.g., data of 5G SRS signals, data of Wi-Fi data packets, data of Bluetooth data packets, data of satellite data packets, etc.) associated with the one(s) of the devices 702. After a determination that the access credentials and the location data are validated, the DPN 102 can grant access to the validated one(s) of the devices 702. After a determination that the access credentials and and/or location data are not validated, the DPN 102 can reject or deny access to the non-validated one(s) of the devices 702.

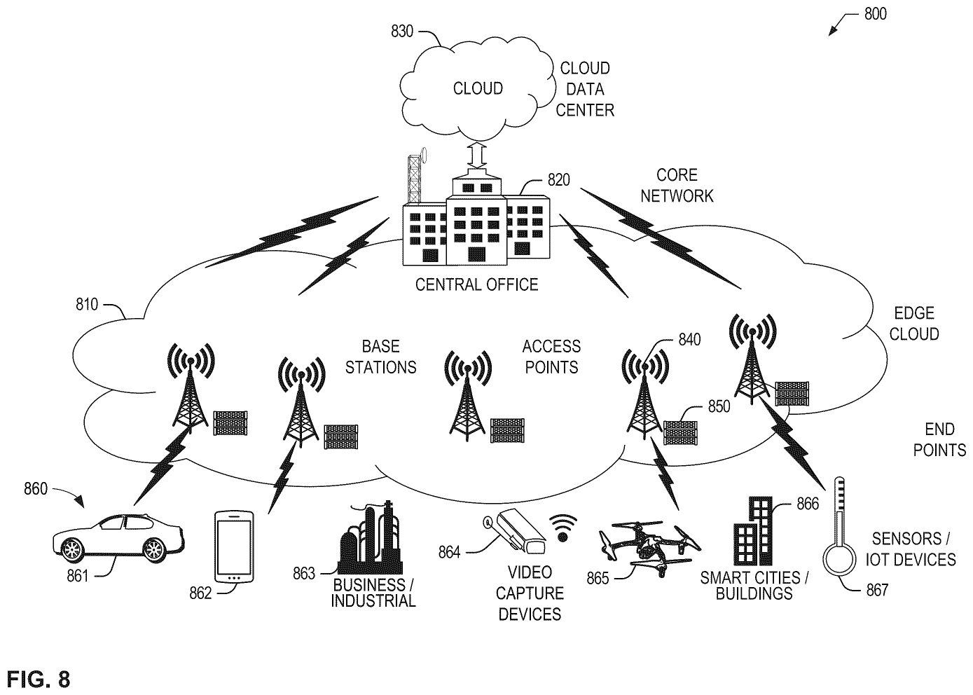

FIG. 8 is a block diagram 800 showing an overview of a configuration for edge computing, which includes a layer of processing referred to in many of the following examples as an “edge cloud”. As shown, the edge cloud 810 is co-located at an edge location, such as an access point or base station 840, a local processing hub 850, or a central office 820, and thus may include multiple entities, devices, and equipment instances. The edge cloud 810 is located much closer to the endpoint (consumer and producer) data sources 860 (e.g., autonomous vehicles 861, user equipment 862, business and industrial equipment 863, video capture devices 864, drones 865, smart cities and building devices 866, sensors and Internet-of-Things (IoT) devices 867, etc.) than the cloud data center 830. Compute, memory, and storage resources that are offered at the edges in the edge cloud 810 are critical to providing ultra-low latency response times for services and functions used by the endpoint data sources 860 as well as reduce network backhaul traffic from the edge cloud 810 toward cloud data center 830 thus improving energy consumption and overall network usages among other benefits.

In some examples, the central office 820, the cloud data center 830, and/or portion(s) thereof, may implement one or more location engines that locate and/or otherwise identify positions of devices of the endpoint (consumer and producer) data sources 860 (e.g., autonomous vehicles 861, user equipment 862, business and industrial equipment 863, video capture devices 864, drones 865, smart cities and building devices 866, sensors and Internet-of-Things (IoT) devices 867, etc.). In some such examples, the central office 820, the cloud data center 830, and/or portion(s) thereof, may implement one or more location engines to execute location detection operations with improved accuracy.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In contrast to the network architecture of FIG. 8, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but is not optimal for highly time varying data, such as a collision, traffic light change, etc. and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage and processing as well as remote cloud data-center based storage and processing. Key performance indicators (KPIs) may be used to identify where sensor data is best transferred and where it is processed or stored. This typically depends on the open system interconnection (OSI) layer dependency of the data. For example, lower layer (physical layer (PHY), MAC, routing, etc.) data typically changes quickly and is better handled locally in order to meet latency requirements. Higher layer data such as Application Layer data is typically less time critical and may be stored and processed in a remote cloud data-center. At a more generic level, an edge computing system may be described to encompass any number of deployments operating in the edge cloud 810, which provide coordination from client and distributed computing devices.

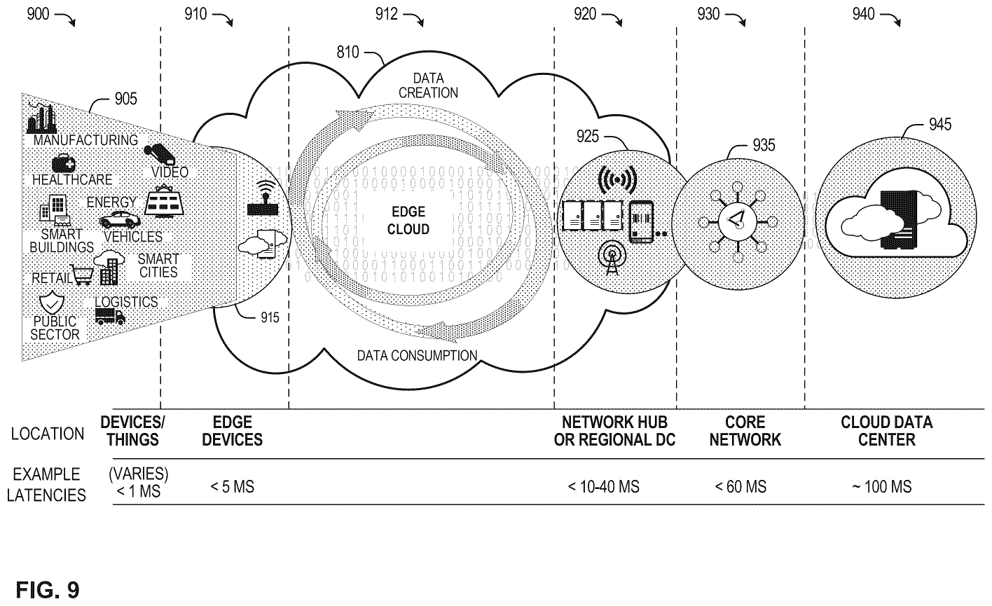

FIG. 9 illustrates operational layers among endpoints, an edge cloud, and cloud computing environments. Specifically, FIG. 9 depicts examples of computational use cases 905, utilizing the edge cloud 810 of FIG. 8 among multiple illustrative layers of network computing. The layers begin at an endpoint (devices and things) layer 900, which accesses the edge cloud 810 to conduct data creation, analysis, and data consumption activities. The edge cloud 810 may span multiple network layers, such as an edge devices layer 910 having gateways, on-premise servers, or network equipment (nodes 915) located in physically proximate edge systems; a network access layer 920, encompassing base stations, radio processing units, network hubs, regional data centers (DC), or local network equipment (equipment 925); and any equipment, devices, or nodes located therebetween (in layer 912, not illustrated in detail). The network communications within the edge cloud 810 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 900, under 5 ms at the edge devices layer 910, to even between 10 to 40 ms when communicating with nodes at the network access layer 920. Beyond the edge cloud 810 are core network 930 and cloud data center 932 layers, each with increasing latency (e.g., between 50-60 ms at the core network layer 930, to 100 or more ms at the cloud data center layer 940). As a result, operations at a core network data center 935 or a cloud data center 945, with latencies of at least 50 to 100 ms or more, will not be able to accomplish many time-critical functions of the use cases 905. Each of these latency values are provided for purposes of illustration and contrast; it will be understood that the use of other access network mediums and technologies may further reduce the latencies. In some examples, respective portions of the network may be categorized as “close edge,” “local edge,” “near edge,” “middle edge,” or “far edge” layers, relative to a network source and destination. For instance, from the perspective of the core network data center 935 or a cloud data center 945, a central office or content data network may be considered as being located within a “near edge” layer (“near” to the cloud, having high latency values when communicating with the devices and endpoints of the use cases 905), whereas an access point, base station, on-premise server, or network gateway may be considered as located within a “far edge” layer (“far” from the cloud, having low latency values when communicating with the devices and endpoints of the use cases 905). It will be understood that other categorizations of a particular network layer as constituting a “close,” “local,” “near,” “middle,” or “far” edge may be based on latency, distance, number of network hops, or other measurable characteristics, as measured from a source in any of the network layers 900-940.

The various use cases 905 may access resources under usage pressure from incoming streams, due to multiple services utilizing the edge cloud. For example, location detection of devices associated with such incoming streams of the various use cases 905 is desired and may be achieved with example location engines as described herein. To achieve results with low latency, the services executed within the edge cloud 810 balance varying requirements in terms of: (a) Priority (throughput or latency) and Quality of Service (QOS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to service level agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 810 may provide the ability to serve and respond to multiple applications of the use cases 905 (e.g., object tracking, location detection, video surveillance, connected cars, etc.) in real-time or near real-time, and meet ultra-low latency requirements for these multiple applications. These advantages enable a whole new class of applications (VNFs), Function-as-a-Service (FaaS), Edge-as-a-Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 810 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 810 (network layers 910-930), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 810.

As such, the edge cloud 810 is formed from network components and functional features operated by and within edge gateway nodes, edge aggregation nodes, or other edge compute nodes among network layers 910-930. The edge cloud 810 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 810 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

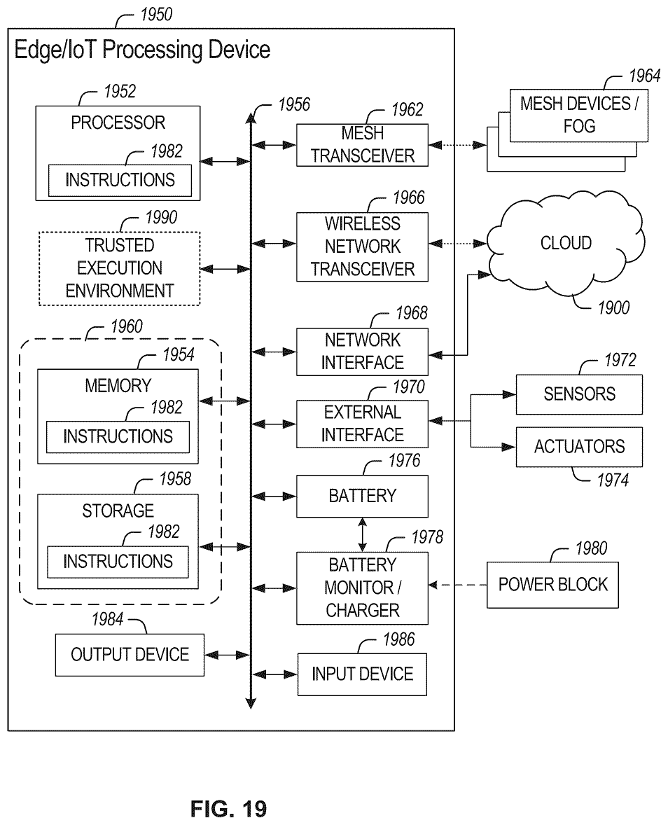

The network components of the edge cloud 810 may be servers, multi-tenant servers, appliance computing devices, and/or any other type of computing devices. For example, the edge cloud 810 may include an appliance computing device that is a self-contained electronic device including a housing, a chassis, a case or a shell. In some examples, the edge cloud 810 may include an appliance to be operated in harsh environmental conditions (e.g., extreme heat or cold ambient temperatures, strong wind conditions, wet or frozen environments, and the like). In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures), and/or enable submergibility. Example housings may include power circuitry to provide power for stationary and/or portable implementations, such as alternating current (AC) power inputs, direct current (DC) power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, light emitting diodes (LEDs), speakers, I/O ports (e.g., universal serial bus (USB)), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include IoT devices. The appliance computing device may include hardware and software components to manage local issues such as device temperature, vibration, resource utilization, updates, power issues, physical and network security, etc. The example processor systems of at least FIGS. 19, 20, 21, and/or 22 illustrate example hardware for implementing an appliance computing device. The edge cloud 810 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

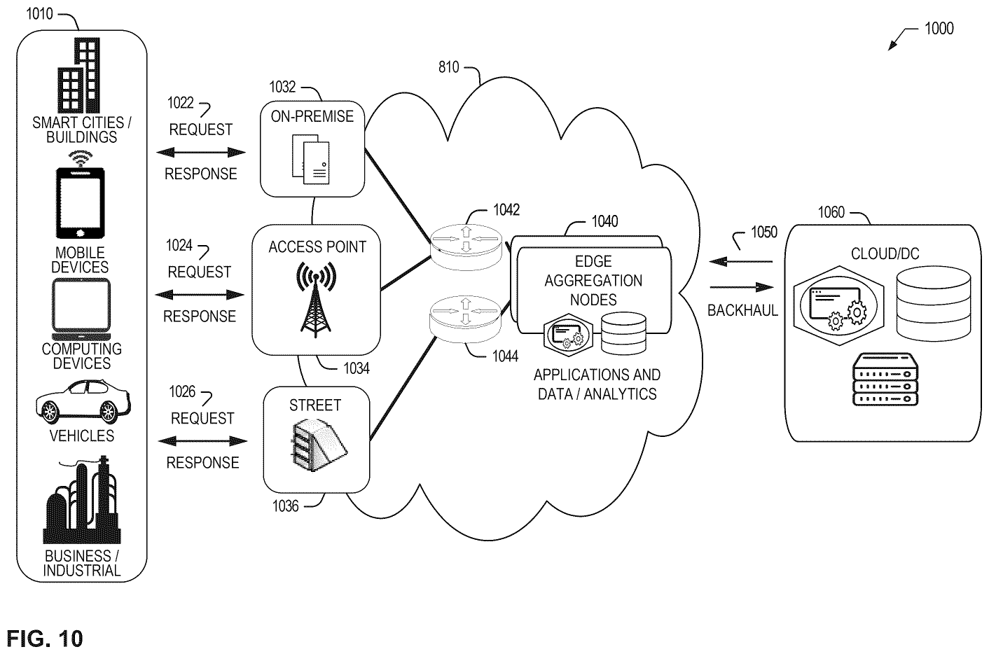

In FIG. 10, various client endpoints 1010 (in the form of mobile devices, computers, autonomous vehicles, business computing equipment, industrial processing equipment) exchange requests and responses that are specific to the type of endpoint network aggregation. For instance, client endpoints 1010 may obtain network access via a wired broadband network, by exchanging requests and responses 1022 through an on-premise network system 1032. Some client endpoints 1010, such as mobile computing devices, may obtain network access via a wireless broadband network, by exchanging requests and responses 1024 through an access point (e.g., cellular network tower) 1034. Some client endpoints 1010, such as autonomous vehicles may obtain network access for requests and responses 1026 via a wireless vehicular network through a street-located network system 1036. However, regardless of the type of network access, the TSP may deploy aggregation points 1042, 1044 within the edge cloud 810 of FIG. 8 to aggregate traffic and requests. Thus, within the edge cloud 810, the TSP may deploy various compute and storage resources, such as at edge aggregation nodes 1040, to provide requested content. The edge aggregation nodes 1040 and other systems of the edge cloud 810 are connected to a cloud or data center (DC) 1060, which uses a backhaul network 1050 to fulfill higher-latency requests from a cloud/data center for websites, applications, database servers, etc. Additional or consolidated instances of the edge aggregation nodes 1040 and the aggregation points 1042, 1044, including those deployed on a single server framework, may also be present within the edge cloud 810 or other areas of the TSP infrastructure. Advantageously, example location engines as described herein may detect and/or otherwise determine locations of the client endpoints 1010 with improved performance and accuracy and reduced latency.

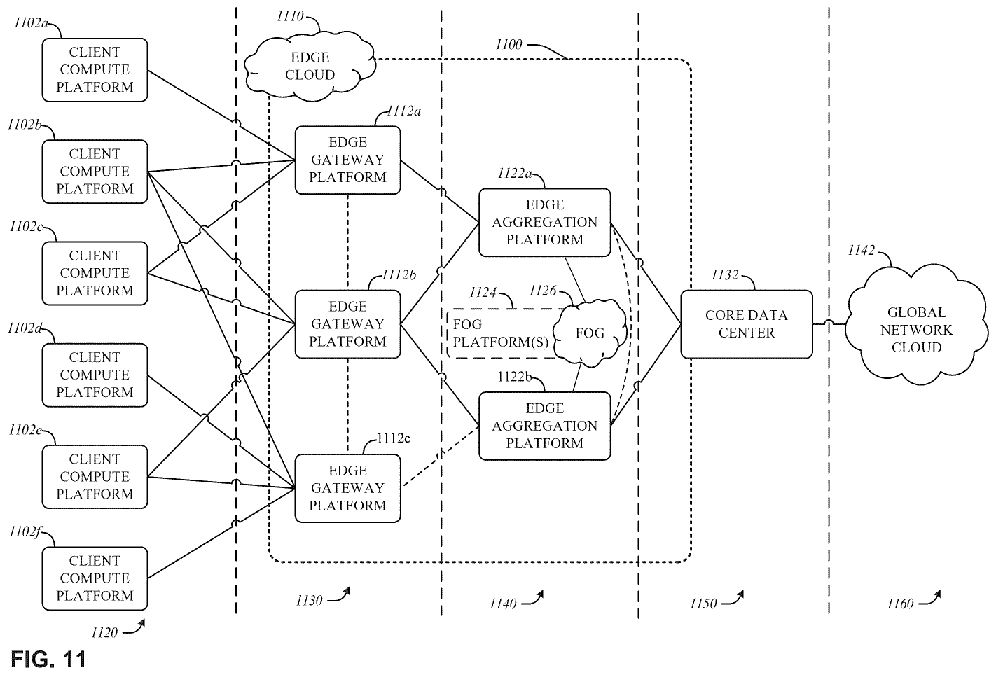

FIG. 11 depicts an example edge computing system 1100 for providing edge services and applications to multi-stakeholder entities, as distributed among one or more client compute platforms 1102, one or more edge gateway platforms 1112, one or more edge aggregation platforms 1122, one or more core data centers 1132, and a global network cloud 1142, as distributed across layers of the edge computing system 1100. The implementation of the edge computing system 1100 may be provided at or on behalf of a telecommunication service provider (“telco”, or “TSP”), internet-of-things service provider, cloud service provider (CSP), enterprise entity, or any other number of entities. Various implementations and configurations of the edge computing system 1100 may be provided dynamically, such as when orchestrated to meet service objectives.

Individual platforms or devices of the edge computing system 1100 are located at a particular layer corresponding to layers 1120, 1130, 1140, 1150, and 1160. For example, the client compute platforms 1102a, 1102b, 1102c, 1102d, 1102e, 1102f are located at an endpoint layer 1120, while the edge gateway platforms 1112a, 1112b, 1112c are located at an edge devices layer 1130 (local level) of the edge computing system 1100. Additionally, the edge aggregation platforms 1122a, 1122b (and/or fog platform(s) 1124, if arranged or operated with or among a fog networking configuration 1126) are located at a network access layer 1140 (an intermediate level). Fog computing (or “fogging”) generally refers to extensions of cloud computing to the edge of an enterprise's network or to the ability to manage transactions across the cloud/edge landscape, typically in a coordinated distributed or multi-node network. Some forms of fog computing provide the deployment of compute, storage, and networking services between end devices and cloud computing data centers, on behalf of the cloud computing locations. Some forms of fog computing also provide the ability to manage the workload/workflow level services, in terms of the overall transaction, by pushing certain workloads to the edge or to the cloud based on the ability to fulfill the overall service level agreement.

Fog computing in many scenarios provides a decentralized architecture and serves as an extension to cloud computing by collaborating with one or more edge node devices, providing the subsequent amount of localized control, configuration and management, and much more for end devices. Furthermore, fog computing provides the ability for edge resources to identify similar resources and collaborate to create an edge-local cloud which can be used solely or in conjunction with cloud computing to complete computing, storage or connectivity related services. Fog computing may also allow the cloud-based services to expand their reach to the edge of a network of devices to offer local and quicker accessibility to edge devices. Thus, some forms of fog computing provide operations that are consistent with edge computing as discussed herein; the edge computing aspects discussed herein are also applicable to fog networks, fogging, and fog configurations. Further, aspects of the edge computing systems discussed herein may be configured as a fog, or aspects of a fog may be integrated into an edge computing architecture.

The core data center 1132 is located at a core network layer 1150 (a regional or geographically central level), while the global network cloud 1142 is located at a cloud data center layer 1160 (a national or world-wide layer). The use of “core” is provided as a term for a centralized network location-deeper in the network-which is accessible by multiple edge platforms or components; however, a “core” does not necessarily designate the “center” or the deepest location of the network. Accordingly, the core data center 1132 may be located within, at, or near the edge cloud 1110. Although an illustrative number of client compute platforms 1102a, 1102b, 1102c, 1102d, 1102c, 1102f; edge gateway platforms 1112a, 1112b, 1112c; edge aggregation platforms 1122a, 1122b; edge core data centers 1132; and global network clouds 1142 are shown in FIG. 11, it should be appreciated that the edge computing system 1100 may include any number of devices and/or systems at each layer. Devices at any layer can be configured as peer nodes and/or peer platforms to each other and, accordingly, act in a collaborative manner to meet service objectives. For example, in additional or alternative examples, the edge gateway platforms 1112a, 1112b, 1112c can be configured as an edge of edges such that the edge gateway platforms 1112a, 1112b, 1112c communicate via peer to peer connections. In some examples, the edge aggregation platforms 1122a, 1122b and/or the fog platform(s) 1124 can be configured as an edge of edges such that the edge aggregation platforms 1122a, 1122b and/or the fog platform(s) communicate via peer to peer connections. Additionally, as shown in FIG. 11, the number of components of respective layers 1120, 1130, 1140, 1150, and 1160 generally increases at each lower level (e.g., when moving closer to endpoints (e.g., client compute platforms 1102a, 1102b, 1102c, 1102d, 1102e, 1102f)). As such, one edge gateway platforms 1112a, 1112b, 1112c may service multiple ones of the client compute platforms 1102a, 1102b, 1102c, 1102d, 1102e, 1102f, and one edge aggregation platform (e.g., one of the edge aggregation platforms 1122a, 1122b) may service multiple ones of the edge gateway platforms 1112a, 1112b, 1112c.

Consistent with the examples provided herein, a client compute platform (e.g., one of the client compute platforms 1102a, 1102b, 1102c, 1102d, 1102e, 1102f) may be implemented as any type of endpoint component, device, appliance, or other thing capable of communicating as a producer or consumer of data. For example, a client compute platform can include a mobile phone, a laptop computer, a desktop computer, a processor platform in an autonomous vehicle, etc. In additional or alternative examples, a client compute platform can include a camera, a sensor, etc. Further, the label “platform,” “node,” and/or “device” as used in the edge computing system 1100 does not necessarily mean that such platform, node, and/or device operates in a client or slave role; rather, any of the platforms, nodes, and/or devices in the edge computing system 1100 refer to individual entities, platforms, nodes, devices, and/or subsystems which include discrete and/or connected hardware and/or software configurations to facilitate and/or use the edge cloud 1110. Advantageously, example location engines as described herein may detect and/or otherwise determine locations of the client compute platforms 1102a, 1102b, 1102c, 1102d, 1102c, 1102f with improved performance and accuracy as well as with reduced latency.

As such, the edge cloud 1110 is formed from network components and functional features operated by and within the edge gateway platforms 1112a, 1112b, 1112c and the edge aggregation platforms 1122a, 1122b of layers 1130, 1140, respectively. The edge cloud 1110 may be implemented as any type of network that provides edge computing and/or storage resources which are proximately located to radio access network (RAN) capable endpoint devices (e.g., mobile computing devices, IoT devices, smart devices, etc.), which are shown in FIG. 11 as the client compute platforms 1102a, 1102b, 1102c, 1102d, 1102e, 1102f. In other words, the edge cloud 1110 may be envisioned as an “edge” which connects the endpoint devices and traditional network access points that serves as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

In some examples, the edge cloud 1110 may form a portion of, or otherwise provide, an ingress point into or across a fog networking configuration 1126 (e.g., a network of fog platform(s) 1124, not shown in detail), which may be implemented as a system-level horizontal and distributed architecture that distributes resources and services to perform a specific function. For instance, a coordinated and distributed network of fog platform(s) 1124 may perform computing, storage, control, or networking aspects in the context of an IoT system arrangement. Other networked, aggregated, and distributed functions may exist in the edge cloud 1110 between the core data center 1132 and the client endpoints (e.g., client compute platforms 1102a, 1102b, 1102c, 1102d, 1102e, 1102f). Some of these are discussed in the following sections in the context of network functions or service virtualization, including the use of virtual edges and virtual services which are orchestrated for multiple tenants.

As discussed in more detail below, the edge gateway platforms 1112a, 1112b, 1112c and the edge aggregation platforms 1122a, 1122b cooperate to provide various edge services and security to the client compute platforms 1102a, 1102b, 1102c, 1102d, 1102c, 1102f. Furthermore, because a client compute platforms (e.g., one of the client compute platforms 1102a, 1102b, 1102c, 1102d, 1102e, 1102f) may be stationary or mobile, a respective edge gateway platform 1112a, 1112b, 1112c may cooperate with other edge gateway platforms to propagate presently provided edge services, relevant service data, and security as the corresponding client compute platforms 1102a, 1102b, 1102c, 1102d, 1102c, 1102f moves about a region. To do so, the edge gateway platforms 1112a, 1112b, 1112c and/or edge aggregation platforms 1122a, 1122b may support multiple tenancy and multiple tenant configurations, in which services from (or hosted for) multiple service providers, owners, and multiple consumers may be supported and coordinated across a single or multiple compute devices.

In examples disclosed herein, edge platforms in the edge computing system 1100 includes meta-orchestration functionality. For example, edge platforms at the far-edge (e.g., edge platforms closer to edge users, the edge devices layer 1130, etc.) can reduce the performance or power consumption of orchestration tasks associated with far-edge platforms so that the execution of orchestration components at far-edge platforms consumes a small fraction of the power and performance available at far-edge platforms.

The orchestrators at various far-edge platforms participate in an end-to-end orchestration architecture. Examples disclosed herein anticipate that the comprehensive operating software framework (such as, open network automation platform (ONAP) or similar platform) will be expanded, or options created within it, so that examples disclosed herein can be compatible with those frameworks. For example, orchestrators at edge platforms implementing examples disclosed herein can interface with ONAP orchestration flows and facilitate edge platform orchestration and telemetry activities. Orchestrators implementing examples disclosed herein act to regulate the orchestration and telemetry activities that are performed at edge platforms, including increasing or decreasing the power and/or resources expended by the local orchestration and telemetry components, delegating orchestration and telemetry processes to a remote computer and/or retrieving orchestration and telemetry processes from the remote computer when power and/or resources are available.

The remote devices described above are situated at alternative locations with respect to those edge platforms that are offloading telemetry and orchestration processes. For example, the remote devices described above can be situated, by contrast, at a near-edge platforms (e.g., the network access layer 1140, the core network layer 1150, a central office, a mini-datacenter, etc.). By offloading telemetry and/or orchestration processes at a near edge platforms, an orchestrator at a near-edge platform is assured of (comparatively) stable power supply, and sufficient computational resources to facilitate execution of telemetry and/or orchestration processes. An orchestrator (e.g., operating according to a global loop) at a near-edge platform can take delegated telemetry and/or orchestration processes from an orchestrator (e.g., operating according to a local loop) at a far-edge platform. For example, if an orchestrator at a near-edge platform takes delegated telemetry and/or orchestration processes, then at some later time, the orchestrator at the near-edge platform can return the delegated telemetry and/or orchestration processes to an orchestrator at a far-edge platform as conditions change at the far-edge platform (e.g., as power and computational resources at a far-edge platform satisfy a threshold level, as higher levels of power and/or computational resources become available at a far-edge platform, etc.).

A variety of security approaches may be utilized within the architecture of the edge cloud 1110. In a multi-stakeholder environment, there can be multiple loadable security modules (LSMs) used to provision policies that enforce the stakeholder's interests including those of tenants. In some examples, other operators, service providers, etc. may have security interests that compete with the tenant's interests. For example, tenants may prefer to receive full services (e.g., provided by an edge platform) for free while service providers would like to get full payment for performing little work or incurring little costs. Enforcement point environments could support multiple LSMs that apply the combination of loaded LSM policies (e.g., where the most constrained effective policy is applied, such as where if any of A, B or C stakeholders restricts access then access is restricted). Within the edge cloud 1110, each edge entity can provision LSMs that enforce the Edge entity interests. The cloud entity can provision LSMs that enforce the cloud entity interests. Likewise, the various fog and IoT network entities can provision LSMs that enforce the fog entity's interests.

In these examples, services may be considered from the perspective of a transaction, performed against a set of contracts or ingredients, whether considered at an ingredient level or a human-perceivable level. Thus, a user who has a service agreement with a service provider, expects the service to be delivered under terms of the SLA. Although not discussed in detail, the use of the edge computing techniques discussed herein may play roles during the negotiation of the agreement and the measurement of the fulfillment of the agreement (e.g., to identify what elements are required by the system to conduct a service, how the system responds to service conditions and changes, and the like).

Additionally, in examples disclosed herein, edge platforms and/or orchestration components thereof may consider several factors when orchestrating services and/or applications in an edge environment. These factors can include next-generation central office smart network functions virtualization and service management, improving performance per watt at an edge platform and/or of orchestration components to overcome the limitation of power at edge platforms, reducing power consumption of orchestration components and/or an edge platform, improving hardware utilization to increase management and orchestration efficiency, providing physical and/or end to end security, providing individual tenant quality of service and/or service level agreement satisfaction, improving network equipment-building system compliance level for each use case and tenant business model, pooling acceleration components, and billing and metering policies to improve an edge environment.

A “service” is a broad term often applied to various contexts, but in general, it refers to a relationship between two entities where one entity offers and performs work for the benefit of another. However, the services delivered from one entity to another must be performed with certain guidelines, which ensure trust between the entities and manage the transaction according to the contract terms and conditions set forth at the beginning, during, and end of the service.

An example relationship among services for use in an edge computing system is described below. In scenarios of edge computing, there are several services, and transaction layers in operation and dependent on each other—these services create a “service chain”. At the lowest level, ingredients compose systems. These systems and/or resources communicate and collaborate with each other in order to provide a multitude of services to each other as well as other permanent or transient entities around them. In turn, these entities may provide human-consumable services. With this hierarchy, services offered at each tier must be transactionally connected to ensure that the individual component (or sub-entity) providing a service adheres to the contractually agreed to objectives and specifications. Deviations at each layer could result in overall impact to the entire service chain.

One type of service that may be offered in an edge environment hierarchy is Silicon Level Services. For instance, Software Defined Silicon (SDSi)-type hardware provides the ability to ensure low level adherence to transactions, through the ability to intra-scale, manage and assure the delivery of operational service level agreements. Use of SDSi and similar hardware controls provide the capability to associate features and resources within a system to a specific tenant and manage the individual title (rights) to those resources. Use of such features is among one way to dynamically “bring” the compute resources to the workload.

For example, an operational level agreement and/or service level agreement could define “transactional throughput” or “timeliness”-in case of SDSi, the system and/or resource can sign up to guarantee specific service level specifications (SLS) and objectives (SLO) of a service level agreement (SLA). For example, SLOs can correspond to particular key performance indicators (KPIs) (e.g., frames per second, floating point operations per second, latency goals, etc.) of an application (e.g., service, workload, etc.) and an SLA can correspond to a platform level agreement to satisfy a particular SLO (e.g., one gigabyte of memory for 10 frames per second). SDSi hardware also provides the ability for the infrastructure and resource owner to empower the silicon component (e.g., components of a composed system that produce metric telemetry) to access and manage (add/remove) product features and freely scale hardware capabilities and utilization up and down. Furthermore, it provides the ability to provide deterministic feature assignments on a per-tenant basis. It also provides the capability to tie deterministic orchestration and service management to the dynamic (or subscription based) activation of features without the need to interrupt running services, client operations or by resetting or rebooting the system.

At the lowest layer, SDSi can provide services and guarantees to systems to ensure active adherence to contractually agreed-to service level specifications that a single resource has to provide within the system. Additionally, SDSi provides the ability to manage the contractual rights (title), usage and associated financials of one or more tenants on a per component, or even silicon level feature (e.g., stockkeeping unit (SKU) features). Silicon level features may be associated with compute, storage or network capabilities, performance, determinism or even features for security, encryption, acceleration, etc. These capabilities ensure not only that the tenant can achieve a specific service level agreement, but also assist with management and data collection, and assure the transaction and the contractual agreement at the lowest manageable component level.

At a higher layer in the services hierarchy, Resource Level Services, includes systems and/or resources which provide (in complete or through composition) the ability to meet workload demands by either acquiring and enabling system level features via SDSi, or through the composition of individually addressable resources (compute, storage and network). At yet a higher layer of the services hierarchy, Workflow Level Services, is horizontal, since service-chains may have workflow level requirements. Workflows describe dependencies between workloads in order to deliver specific service level objectives and requirements to the end-to-end service. These services may include features and functions like high-availability, redundancy, recovery, fault tolerance or load-leveling (we can include lots more in this). Workflow services define dependencies and relationships between resources and systems, describe requirements on associated networks and storage, as well as describe transaction level requirements and associated contracts in order to assure the end-to-end service. Workflow Level Services are usually measured in Service Level Objectives and have mandatory and expected service requirements.

At yet a higher layer of the services hierarchy, Business Functional Services (BFS) are operable, and these services are the different elements of the service which have relationships to each other and provide specific functions for the customer. In the case of Edge computing and within the example of Autonomous Driving, business functions may be composing the service, for instance, of a “timely arrival to an event”—this service would require several business functions to work together and in concert to achieve the goal of the user entity: GPS guidance, RSU (Road Side Unit) awareness of local traffic conditions, Payment history of user entity, Authorization of user entity of resource(s), etc. Furthermore, as these BFS(s) provide services to multiple entities, each BFS manages its own SLA and is aware of its ability to deal with the demand on its own resources (Workload and Workflow). As requirements and demand increases, it communicates the service change requirements to Workflow and resource level service entities, so they can, in-turn provide insights to their ability to fulfill. This step assists the overall transaction and service delivery to the next layer.

At the highest layer of services in the service hierarchy, Business Level Services (BLS), is tied to the capability that is being delivered. At this level, the customer or entity might not care about how the service is composed or what ingredients are used, managed, and/or tracked to provide the service(s). The primary objective of business level services is to attain the goals set by the customer according to the overall contract terms and conditions established between the customer and the provider at the agreed to a financial agreement. BLS(s) are comprised of several Business Functional Services (BFS) and an overall SLA.

This arrangement and other service management features described herein are designed to meet the various requirements of edge computing with its unique and complex resource and service interactions. This service management arrangement is intended to inherently address several of the resource basic services within its framework, instead of through an agent or middleware capability. Services such as: locate, find, address, trace, track, identify, and/or register may be placed immediately in effect as resources appear on the framework, and the manager or owner of the resource domain can use management rules and policies to ensure orderly resource discovery, registration and certification.

Moreover, any number of edge computing architectures described herein may be adapted with service management features. These features may enable a system to be constantly aware and record information about the motion, vector, and/or direction of resources as well as fully describe these features as both telemetry and metadata associated with the devices. These service management features can be used for resource management, billing, and/or metering, as well as an element of security. The same functionality also applies to related resources, where a less intelligent device, like a sensor, might be attached to a more manageable resource, such as an edge gateway. The service management framework is made aware of change of custody or encapsulation for resources. Since nodes and components may be directly accessible or be managed indirectly through a parent or alternative responsible device for a short duration or for its entire lifecycle, this type of structure is relayed to the service framework through its interface and made available to external query mechanisms.

Additionally, this service management framework is always service aware and naturally balances the service delivery requirements with the capability and availability of the resources and the access for the data upload the data analytics systems. If the network transports degrade, fail or change to a higher cost or lower bandwidth function, service policy monitoring functions provide alternative analytics and service delivery mechanisms within the privacy or cost constraints of the user. With these features, the policies can trigger the invocation of analytics and dashboard services at the edge ensuring continuous service availability at reduced fidelity or granularity. Once network transports are re-established, regular data collection, upload and analytics services can resume.

The deployment of a multi-stakeholder edge computing system may be arranged and orchestrated to enable the deployment of multiple services and virtual edge instances, among multiple edge platforms and subsystems, for use by multiple tenants and service providers. In a system example applicable to a cloud service provider (CSP), the deployment of an edge computing system may be provided via an “over-the-top” approach, to introduce edge computing platforms as a supplemental tool to cloud computing. In a contrasting system example applicable to a telecommunications service provider (TSP), the deployment of an edge computing system may be provided via a “network-aggregation” approach, to introduce edge computing platforms at locations in which network accesses (from different types of data access networks) are aggregated. However, these over-the-top and network aggregation approaches may be implemented together in a hybrid or merged approach or configuration.

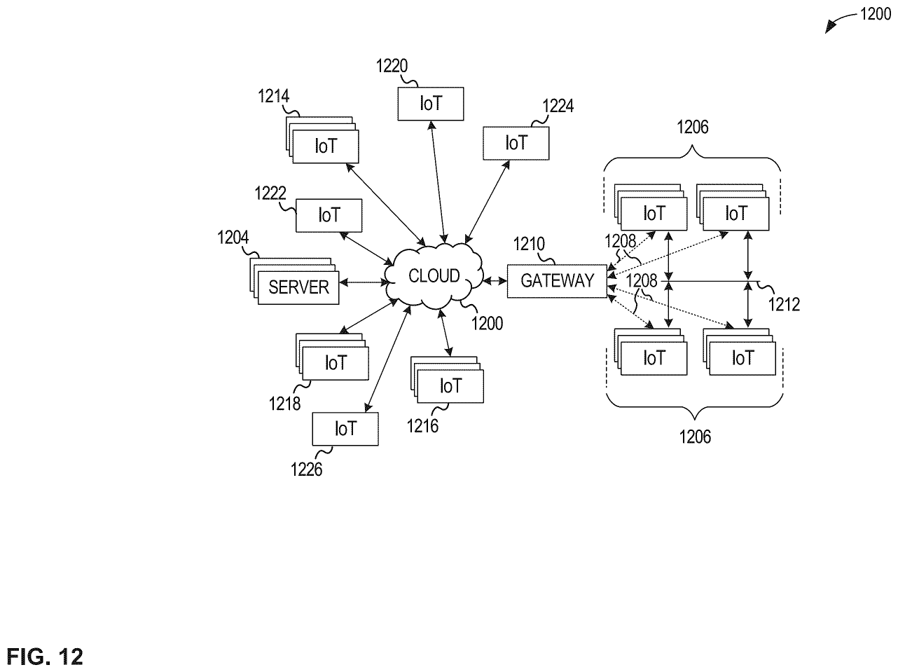

FIG. 12 illustrates a drawing of a cloud computing network, or cloud 1200, in communication with a number of Internet of Things (IoT) devices. The cloud 1200 may represent the Internet, or may be a local area network (LAN), or a wide area network (WAN), such as a proprietary network for a company. The IoT devices may include any number of different types of devices, grouped in various combinations. For example, a traffic control group 1206 may include IoT devices along streets in a city. These IoT devices may include stoplights, traffic flow monitors, cameras, weather sensors, and the like. The traffic control group 1206, or other subgroups, may be in communication with the cloud 1200 through wired or wireless links 1208, such as low-power wide-area (LPWA) links, and the like. Further, a wired or wireless sub-network 1212 may allow the IoT devices to communicate with each other, such as through a local area network, a wireless local area network, and the like. The IoT devices may use another device, such as a gateway 1210 or 1228 to communicate with remote locations such as the cloud 1200; the IoT devices may also use one or more servers 1230 to facilitate communication with the cloud 1200 or with the gateway 1210. For example, the one or more servers 1230 may operate as an intermediate network node to support a local Edge cloud or fog implementation among a local area network. Further, the gateway 1228 that is depicted may operate in a cloud-to-gateway-to-many Edge devices configuration, such as with the various IoT devices 1214, 1220, 1224 being constrained or dynamic to an assignment and use of resources in the cloud 1200.

Other example groups of IoT devices may include remote weather stations 1214, local information terminals 1216, alarm systems 1218, automated teller machines 1220, alarm panels 1222, or moving vehicles, such as emergency vehicles 1224 or other vehicles 1226, among many others. Each of these IoT devices may be in communication with other IoT devices, with servers 1204, with another IoT fog device or system (not shown), or a combination therein. The groups of IoT devices may be deployed in various residential, commercial, and industrial settings (including in both private or public environments). Advantageously, example location engines as described herein may achieve location detection of one(s) of the IoT devices of the traffic control group 1206, one(s) of the IoT devices 1214, 1216, 1218, 1220, 1222, 1224, 1226, etc., and/or a combination thereof with improved performance, improved accuracy, and/or reduced latency.

As may be seen from FIG. 12, a large number of IoT devices may be communicating through the cloud 1200. This may allow different IoT devices to request or provide information to other devices autonomously. For example, a group of IoT devices (e.g., the traffic control group 1206) may request a current weather forecast from a group of remote weather stations 1214, which may provide the forecast without human intervention. Further, an emergency vehicle 1224 may be alerted by an automated teller machine 1220 that a burglary is in progress. As the emergency vehicle 1224 proceeds towards the automated teller machine 1220, it may access the traffic control group 1206 to request clearance to the location, for example, by lights turning red to block cross traffic at an intersection in sufficient time for the emergency vehicle 1224 to have unimpeded access to the intersection.

Clusters of IoT devices, such as the remote weather stations 1214 or the traffic control group 1206, may be equipped to communicate with other IoT devices as well as with the cloud 1200. This may allow the IoT devices to form an ad-hoc network between the devices, allowing them to function as a single device, which may be termed a fog device or system (e.g., as described above with reference to FIG. 11).

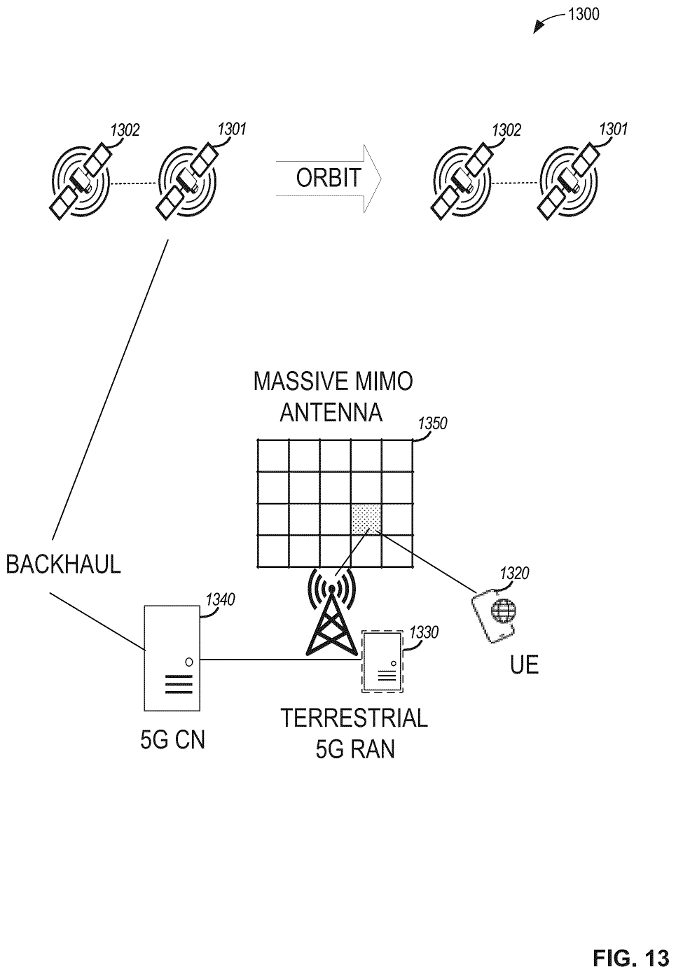

FIG. 13 illustrates network connectivity in non-terrestrial network (NTN) supported by a satellite constellation and a terrestrial network (e.g., mobile cellular network) settings, according to an example. As shown, a satellite constellation (e.g., a Low Earth Orbit constellation) may include multiple satellites 1301, 1302, which are connected to each other and to one or more terrestrial networks. Specifically, the satellite constellation is connected to a backhaul network, which is in turn connected to a 5G core network 1340. The 5G core network is used to support 5G communication operations at the satellite network and at a terrestrial 5G radio access network (RAN) 1330.

FIG. 13 also depicts the use of the terrestrial 5G RAN 1330, to provide radio connectivity to a user equipment (UE) 1320 via a massive multiple input, multiple output (MIMO) antenna 1350. It will be understood that a variety of network communication components and units are not depicted in FIG. 13 for purposes of simplicity. With these basic entities in mind, the following techniques describe ways in which terrestrial and satellite networks can be extended for various Edge computing scenarios, including UE access that directly connects to one or more satellite constellations in addition to the backhaul network depicted in FIG. 13. Alternatively, the illustrated example of FIG. 13 may be applicable to other cellular technologies (e.g., 6G and the like).

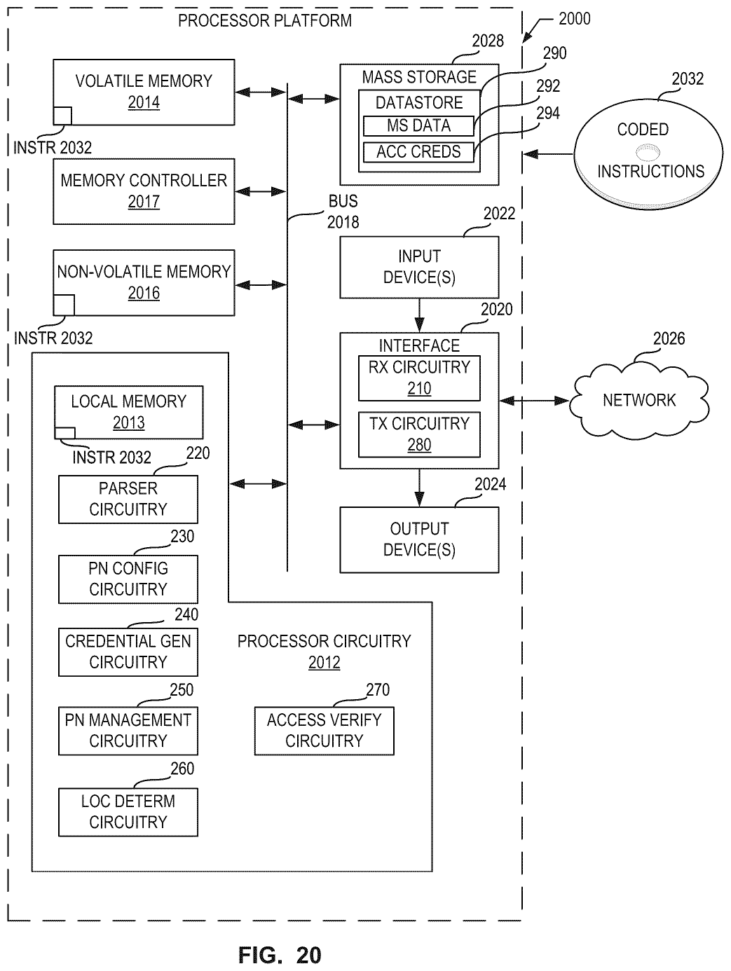

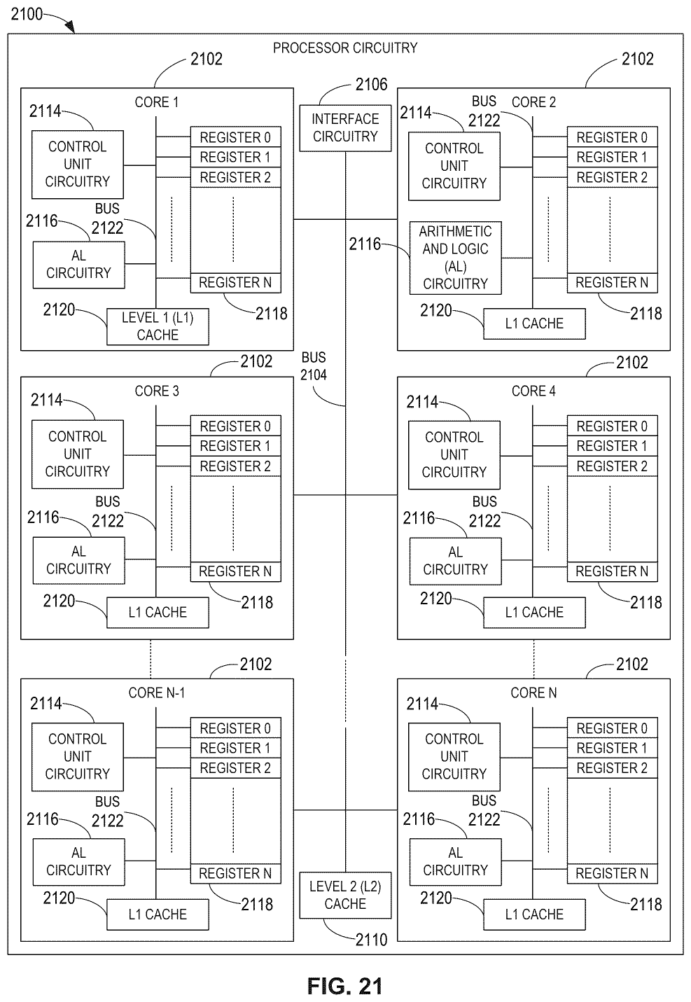

Flowcharts representative of example machine readable instructions, which may be executed to configure processor circuitry to implement the DPN circuitry 200 of FIG. 2, are shown in FIGS. 14-18. The machine readable instructions may be one or more executable programs or portion(s) of an executable program for execution by processor circuitry, such as the processor circuitry 1960 shown in the example IoT device 1950 discussed below in connection with FIG. 19, the processor circuitry 2012 shown in the example processor platform 2000 discussed below in connection with FIG. 20, and/or the example processor circuitry discussed below in connection with FIGS. 21 and/or 22. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 14-18, many other methods of implementing the example DPN circuitry 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 14-18 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 14 is a flowchart representative of example machine readable instructions and/or example operations 1400 that may be executed and/or instantiated by processor circuitry to facilitate communication associated with user equipment using a private network. The example machine readable instructions and/or the example operations 1400 of FIG. 14 begin at block 1402, at which the DPN circuitry 200 determines a fixed geographical area of a private network. For example, at block 1402, the private network configuration circuitry 230 determines a fixed geographical area of a private network.

In the illustrated example of FIG. 14, at block 1404, the DPN circuitry 200 determines a quantity of terrestrial network cells to serve user equipment (UEs) within the fixed geographical area. For example, at block 1404, the private network configuration circuitry 230 determines a quantity of terrestrial network cells to serve Ues within the fixed geographical area of the private network. At block 1406, the DPN circuitry 200 determines a quantity of non-terrestrial network cells to serve Ues within the fixed geographical area. For example, at block 1406, the private network configuration circuitry 230 determines a quantity of non-terrestrial network cells to serve Ues within the fixed geographical area of the private network.

In the illustrated example of FIG. 14, at block 1408, the DPN circuitry 200 generates a fixed terrestrial network coverage grid. For example, at block 1408, the private network configuration circuitry 230 generates a fixed terrestrial network coverage grid. At block 1410, the DPN circuitry 200 generates a fixed non-terrestrial network coverage grid. For example, at block 1410, the private network configuration circuitry 230 generates a fixed non-terrestrial network coverage grid.

In the illustrated example of FIG. 14, at block 1412, the DPN circuitry 200 activates one or more private network terrestrial network nodes in alignment with the terrestrial network coverage grid. For example, at block 1412, the private network configuration circuitry 230 activates one or more private network terrestrial network nodes in alignment with the terrestrial network coverage grid. At block 1414, the DPN circuitry 200 activates one or more private network non-terrestrial network nodes in alignment with the non-terrestrial network coverage grid. For example, at block 1414, the private network configuration circuitry 230 activates one or more private network non-terrestrial network nodes in alignment with the non-terrestrial network coverage grid.

In the illustrated example of FIG. 14, at block 1416, the DPN circuitry 200 facilitates communication associated with the Ues using the private network. For example, the receiver circuitry 210, the private network management circuitry 250, and/or the transmitter circuitry 280 facilitate communication with one or more Ues in the private network. Additionally, at block 1416, location monitoring occurs per a policy (e.g., an enterprise DPN policy) specifically via periodic/aperiodic LMF Triggered UE/Device Location verification. For example, at block 1416, the access verification circuitry 270 determines whether to permit and/or deny one or more Ues access to the private network based on location data determined by the location determination circuitry 260.

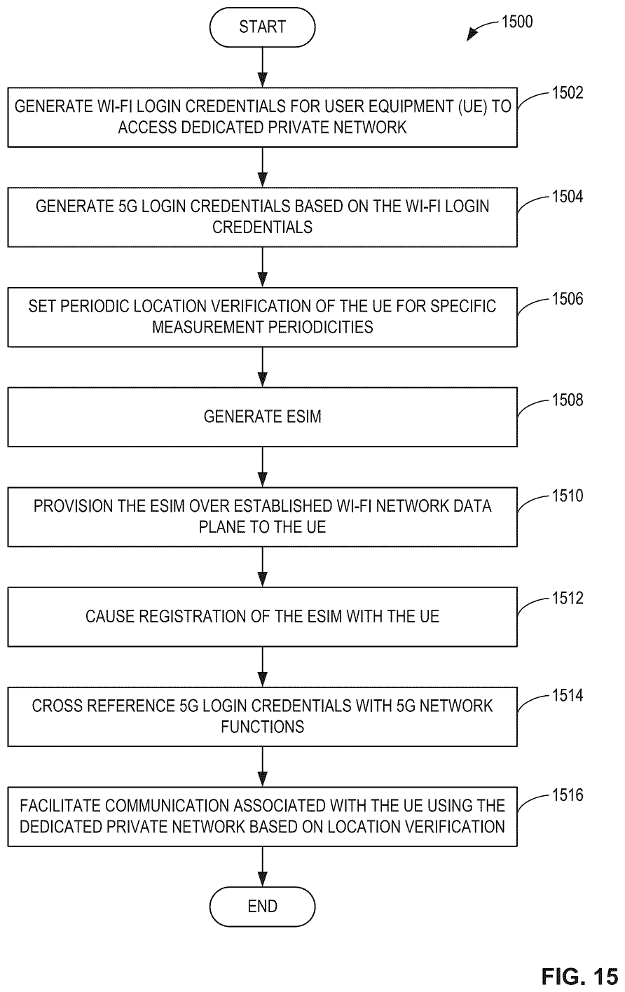

FIG. 15 is another flowchart representative of example machine readable instructions and/or example operations 1500 that may be executed and/or instantiated by processor circuitry to facilitate communication associated with user equipment using a private network. The example machine readable instructions and/or the example operations 1500 of FIG. 15 begin at block 1502, at which the DPN circuitry 200 generates Wi-Fi login credentials for user equipment (UE) to access a dedicated private network. For example, at block 1502, the credential generation circuitry 240 generates Wi-Fi login credentials for a UE to access a dedicated private network.

In the illustrated example of FIG. 15, at block 1504, the DPN circuitry 200 generates 5G login credentials based on the Wi-Fi login credentials. For example, at block 1504, the credential generation circuitry 240 generates the 5G login credentials based on the Wi-Fi login credentials. In some examples, at block 1504, the credential generation circuitry 240 executes and/or instantiates a hash algorithm or function based on the Wi-Fi login credentials to generate the 5G login credentials. At block 1506, the DPN circuitry 200 sets a periodic location verification of the UE for specific measurement periodicities. In some examples, location verification periodicity can range from several times a second to once a day depending on the DPN policy. For example, at block 1506, the access verification circuitry 270 sets a periodic location verification of the UE for specific measurement periodicities. In some examples, to set the periodic location verification of a UE, the access verification circuitry 270 instructs the parser circuitry 220 to parse 5G L1 data received from the UE for location data at a frequency specified by an SLA associated with the UE. Additionally, in some such examples, to set the periodic location verification of the UE, the access verification circuitry 270 instructs the location determination circuitry 260 to determine the location of the UE based on the location data.

In the illustrated example of FIG. 15, at block 1508, the DPN circuitry 200 generates an eSIM. For example, at block 1508, the credential generation circuitry 240 generates an eSIM based on the 5G login credentials. At block 1510, the DPN circuitry 200 provisions the eSIM over an established Wi-Fi network data plane to the UE. For example, at block 1510, the credential generation circuitry 240 causes transmission of the eSIM to the UE via the transmitter circuitry 280. In some examples, at block 1510, the credential generation circuitry 240 causes the Wi-Fi AP controller 112 to transmit the eSIM to the UE via the first Wi-Fi AP 110. At block 1512, the DPN circuitry 200 causes registration of the eSIM with the UE. For example, based on receipt of the eSIM at the UE, the UE registers the eSIM. As such, by causing transmission of the eSIM to the UE, the credential generation circuitry 240 causes registration of the eSIM with the UE.

In the illustrated example of FIG. 15, at block 1514, the DPN circuitry 200 cross references 5G login credentials with 5G network functions. For example, at block 1514, the access verification circuitry 270 cross references the 5G login credentials with 5G network functions. In some examples, at block 1514, the access verification circuitry 270 cross references the 5G login credentials with one or more of an LMF, a UDM, and an AUSF executed and/or instantiated by the DPN circuitry 200. At block 1516, the DPN circuitry 200 facilitates communication associated with the UE using the dedicated private network based on location verification.

For example, at block 1516, the receiver circuitry 210, the private network management circuitry 250, and/or the transmitter circuitry 280 facilitate communication with one or more Ues in the private network. Additionally, at block 1516, location monitoring occurs per a policy (e.g., an enterprise DPN policy) specifically via periodic/aperiodic LMF Triggered UE/Device Location verification. For example, at block 1516, the access verification circuitry 270 determines whether to permit and/or deny one or more Ues access to the private network based on location data determined by the location determination circuitry 260.

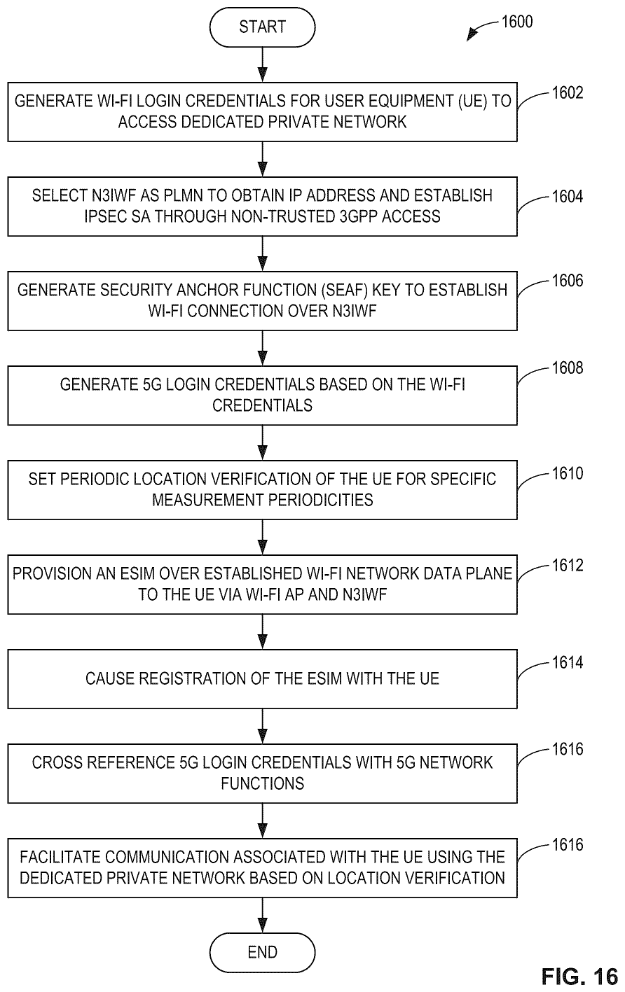

FIG. 16 is another flowchart representative of example machine readable instructions and/or example operations 1600 that may be executed and/or instantiated by processor circuitry to facilitate communication associated with user equipment using a private network. The example machine readable instructions and/or the example operations 1600 of FIG. 16 begin at block 1602, at which the DPN circuitry 200 generates Wi-Fi login credentials for user equipment (UE) to access a dedicated private network. For example, at block 1602, the credential generation circuitry 240 generates Wi-Fi login credentials for a UE to access a dedicated private network.

In the illustrated example of FIG. 16, at block 1604, the DPN circuitry 200 selects N3IWF as a PLMN to obtain an IP address and establish an Ipsec SA through non-trusted 3GPP access. For example, at block 1604, the receiver circuitry 210 and/or the transmitter circuitry 280 select N3IWF as a PLMN to obtain an IP address and establish an Ipsec SA through non-trusted 3GPP access. In the example of FIG. 16, at block 1606, the DPN circuitry 200 generates a security anchor function (SEAF) key to establish a Wi-Fi connection over N3IWF. For example, at block 1606, the private network management circuitry 250 generates a SEAF key to establish a Wi-Fi connection over N3IWF. In some examples, at block 1606, the private network management circuitry 250 utilizes an AUSF executed and/or instantiated by the DPN circuitry 200 to generate the SEAF key.

In the illustrated example of FIG. 16, at block 1608, the DPN circuitry 200 generates 5G login credentials based on the Wi-Fi login credentials. For example, at block 1608, the credential generation circuitry 240 generates the 5G login credentials based on the Wi-Fi login credentials. In some examples, at block 1608, the credential generation circuitry 240 executes and/or instantiates a hash algorithm or function based on the Wi-Fi login credentials to generate the 5G login credentials. At block 1610, the DPN circuitry 200 sets a periodic location verification of the UE for specific measurement periodicities. For example, at block 1610, the access verification circuitry 270 sets a periodic location verification of the UE for specific measurement periodicities. In some examples, to set the periodic location verification of a UE, the access verification circuitry 270 instructs the parser circuitry 220 to parse 5G L1 data received from the UE for location data at a frequency specified by an SLA associated with the UE. Additionally, in some such examples, to set the periodic location verification of the UE, the access verification circuitry 270 instructs the location determination circuitry 260 to determine the location of the UE based on the location data.

In the illustrated example of FIG. 16, at block 1612, the DPN circuitry 200 provisions an eSIM over an established Wi-Fi network data plane to the UE via a Wi-Fi AP and N3IWF. For example, at block 1612, the credential generation circuitry 240 causes transmission of the eSIM to the UE via the transmitter circuitry 280. In some examples, at block 1612, the credential generation circuitry 240 causes the N3IWF 120 to transmit the eSIM to the UE via the second Wi-Fi AP 114. At block 1614, the DPN circuitry 200 causes registration of the eSIM with the UE. For example, based on receipt of the eSIM at the UE, the UE registers the eSIM. As such, by causing transmission of the eSIM to the UE, the credential generation circuitry 240 causes registration of the eSIM with the UE.

In the illustrated example of FIG. 16, at block 1616, the DPN circuitry 200 cross references 5G login credentials with 5G network functions. For example, at block 1616, the access verification circuitry 270 cross references the 5G login credentials with 5G network functions. In some examples, at block 1616, the access verification circuitry 270 cross references the 5G login credentials with one or more of an LMF, a UDM, and an AUSF executed and/or instantiated by the DPN circuitry 200. At block 1618, the DPN circuitry 200 facilitates communication associated with the UE using the dedicated private network based on location verification.

For example, at block 1618, the receiver circuitry 210, the private network management circuitry 250, and/or the transmitter circuitry 280 facilitate communication with one or more Ues in the private network. Additionally, at block 1618, location monitoring occurs per a policy (e.g., an enterprise DPN policy) specifically via periodic/aperiodic LMF Triggered UE/Device Location verification. For example, at block 1618, the access verification circuitry 270 determines whether to permit and/or deny one or more Ues access to the private network based on location data determined by the location determination circuitry 260.

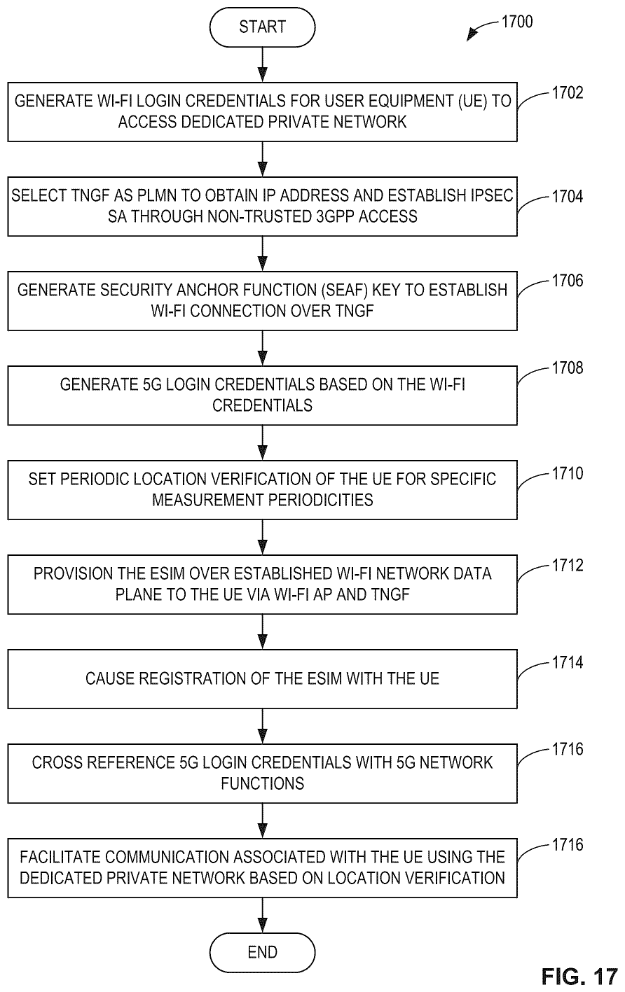

FIG. 17 is another flowchart representative of example machine readable instructions and/or example operations 1700 that may be executed and/or instantiated by processor circuitry to facilitate communication associated with user equipment using a private network. The example machine readable instructions and/or the example operations 1700 of FIG. 17 begin at block 1702, at which the DPN circuitry 200 generates Wi-Fi login credentials for user equipment (UE) to access a dedicated private network. For example, at block 1702, the credential generation circuitry 240 generates Wi-Fi login credentials for a UE to access a dedicated private network.

In the illustrated example of FIG. 17, at block 1704, the DPN circuitry 200 selects TNGF as a PLMN to obtain an IP address and establish an Ipsec SA through trusted non-3GPP access. For example, at block 1704, the receiver circuitry 210 and/or the transmitter circuitry 280 select TNGF as a PLMN to obtain an IP address and establish an Ipsec SA through non-trusted 3GPP access. In the example of FIG. 17, at block 1706, the DPN circuitry 200 generates a security anchor function (SEAF) key to establish a Wi-Fi connection over TNGF. For example, at block 1706, the private network management circuitry 250 generates a SEAF key to establish a Wi-Fi connection over TNGF. In some examples, at block 1706, the private network management circuitry 250 utilizes an AUSF executed and/or instantiated by the DPN circuitry 200 to generate the SEAF key.

In the illustrated example of FIG. 17, at block 1708, the DPN circuitry 200 generates 5G login credentials based on the Wi-Fi login credentials. For example, at block 1708, the credential generation circuitry 240 generates the 5G login credentials based on the Wi-Fi login credentials. In some examples, at block 1708, the credential generation circuitry 240 executes and/or instantiates a hash algorithm or function based on the Wi-Fi login credentials to generate the 5G login credentials. At block 1710, the DPN circuitry 200 sets a periodic location verification of the UE for specific measurement periodicities. For example, at block 1710, the access verification circuitry 270 sets a periodic location verification of the UE for specific measurement periodicities. In some examples, to set the periodic location verification of a UE, the access verification circuitry 270 instructs the parser circuitry 220 to parse 5G L1 data received from the UE for location data at a frequency specified by an SLA associated with the UE. Additionally, in some such examples, to set the periodic location verification of the UE, the access verification circuitry 270 instructs the location determination circuitry 260 to determine the location of the UE based on the location data.

In the illustrated example of FIG. 17, at block 1712, the DPN circuitry 200 provisions an eSIM over an established Wi-Fi network data plane to the UE via a Wi-Fi AP and TNGF. For example, at block 1712, the credential generation circuitry 240 causes transmission of the eSIM to the UE via the transmitter circuitry 280. In some examples, at block 1712, the credential generation circuitry 240 causes the TNGF 122 to transmit the eSIM to the UE via the third Wi-Fi AP 116. At block 1714, the DPN circuitry 200 causes registration of the eSIM with the UE. For example, based on receipt of the eSIM at the UE, the UE registers the eSIM. As such, by causing transmission of the eSIM to the UE, the credential generation circuitry 240 causes registration of the eSIM with the UE.

In the illustrated example of FIG. 17, at block 1716, the DPN circuitry 200 cross references 5G login credentials with 5G network functions. For example, at block 1716, the access verification circuitry 270 cross references the 5G login credentials with 5G network functions. In some examples, at block 1716, the access verification circuitry 270 cross references the 5G login credentials with one or more of an LMF, a UDM, and an AUSF executed and/or instantiated by the DPN circuitry 200. At block 1718, the DPN circuitry 200 facilitates communication associated with the UE using the dedicated private network based on location verification.

For example, at block 1718, the receiver circuitry 210, the private network management circuitry 250, and/or the transmitter circuitry 280 facilitate communication with one or more Ues in the private network. Additionally, at block 1718, location monitoring occurs per a policy (e.g., an enterprise DPN policy) specifically via periodic/aperiodic LMF Triggered UE/Device Location verification. For example, at block 1718, the access verification circuitry 270 determines whether to permit and/or deny one or more Ues access to the private network based on location data determined by the location determination circuitry 260.

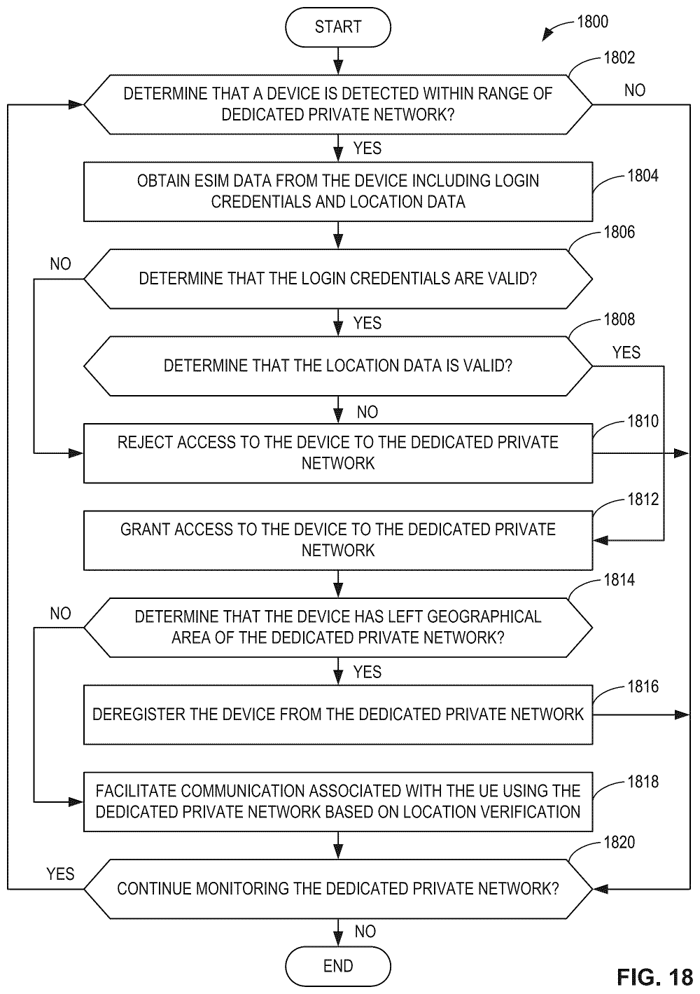

FIG. 18 is a flowchart representative of example machine readable instructions and/or example operations 1800 that may be executed and/or instantiated by processor circuitry to validate access to a private network by a device. The example machine readable instructions and/or the example operations 1800 of FIG. 18 begin at block 1802, at which the DPN circuitry 200 determines whether a device is detected within range of a dedicated private network. For example, at block 1802, the location determination circuitry 260 determines whether a device is detected within range of a dedicated private network. If, at block 1802, the DPN circuitry 200 determines that a device is not detected within range of the dedicated private network, control proceeds to block 1820, otherwise (e.g., if the DPN circuitry 200 determines that a device is detected within range of the dedicated private network) control proceeds to block 1804.

In the illustrated example of FIG. 18, at block 1804, the DPN circuitry 200 obtains eSIM data from the device including login credentials and location data. For example, at block 1804, the private network management circuitry 250 obtains eSIM data, including login credentials and location data, from the device. At block 1806, the DPN circuitry 200 determines whether the login credentials are valid. For example, at block 1806, the access verification circuitry 270 determines whether the login credentials are valid.

In the illustrated example of FIG. 18, if, at block 1806, the DPN circuitry 200 determines that the login credentials are not valid, control proceeds to block 1810. If, at block 1806, the DPN circuitry 200 determines that the login credentials are valid, control proceeds to block 1808. At block 1808, the DPN circuitry 200 determines whether the location data is valid. For example, at block 1808, the access verification circuitry 270 determines whether a location of the device (e.g., determined by the location determination circuitry 260 based on the location data) is within the geographical area of the dedicated private network. If, at block 1808, the DPN circuitry 200 determines that the location data is not valid, control proceeds to block 1810, at which the DPN circuitry 200 rejects access to the device to the dedicated private network. For example, at block 1810, the access verification circuitry 270 rejects access to the device to the dedicated private network.

In the illustrated example of FIG. 18, if, at block 1808, the DPN circuitry 200 determines that the location data is valid, control proceeds to block 1812, at which the DPN circuitry 200 grants access to the device to the dedicated private network. For example, at block 1812, the access verification circuitry 270 grants access to the device to the dedicated private network. At block 1814, the DPN circuitry 200 determines whether the device has left a geographical area of the dedicated private network. For example, at block 1814, the location determination circuitry 260 determines whether the device has left a geographical area of the dedicated private network. If, at block 1814, the DPN circuitry 200 determines that the device has left a geographical area of the dedicated private network, control proceeds to block 1816, at which the DPN circuitry 200 deregisters the device from the dedicated private network. For example, at block 1816, the access verification circuitry 270 deregisters the device from the dedicated private network.

In the illustrated example of FIG. 18, if, at block 1814, the DPN circuitry 200 determines that the device has not left a geographical area of the dedicated private network, control proceeds to block 1818, at which the DPN circuitry 200 facilitates communication associated with the UE using the dedicated private network based on location verification. For example, at block 1818, the receiver circuitry 210, the private network management circuitry 250, and/or the transmitter circuitry 280 facilitate communication associated with the UE using the dedicated private network based on location verification.

In the illustrated example of FIG. 18, at block 1820, the DPN circuitry 200 determines whether to continue monitoring the dedicated private network. For example, the private network management circuitry 250 determines whether to continue monitoring the dedicated private network. If, at block 1820, the DPN circuitry 200 determines to continue monitoring the dedicated private network, control returns to block 1802, otherwise the example machine readable instructions and/or the example operations 1800 of FIG. 18 conclude.

FIG. 19 is a block diagram of an example of components that may be present in an IoT device 1950 for implementing the techniques described herein. In some examples, the IoT device 1950 may implement the DPN circuitry 200 of FIG. 2. The IoT device 1950 may include any combinations of the components shown in the example or referenced in the disclosure above. The components may be implemented as Ics, portions thereof, discrete electronic devices, or other modules, logic, hardware, software, firmware, or a combination thereof adapted in the ioT device 1950, or as components otherwise incorporated within a chassis of a larger system. Additionally, the block diagram of FIG. 19 is intended to depict a high-level view of components of the IoT device 1950. However, some of the components shown may be omitted, additional components may be present, and different arrangement of the components shown may occur in other implementations.

The IoT device 1950 may include processor circuitry in the form of, for example, a processor 1952, which may be a microprocessor, a multi-core processor, a multithreaded processor, an ultra-low voltage processor, an embedded processor, or other known processing elements. The processor 1952 may be a part of a system on a chip (SoC) in which the processor 1952 and other components are formed into a single integrated circuit, or a single package, such as the Edison™ or Galileo™ SoC boards from Intel. As an example, the processor 1952 may include an Intel® Architecture Core™ based processor, such as a Quark™, an Atom™, an i3, an i5, an i7, or an microcontroller unit (MCU) class (MCU-class) processor, or another such processor available from Intel® Corporation, Santa Clara, CA. However, any number other processors may be used, such as available from Advanced Micro Devices, Inc. (AMD) of Sunnyvale, CA, a microprocessor without Interlocked Pipelined Stages (MIPS) based (MIPS-based) design from MIPS Technologies, Inc. of Sunnyvale, CA, an ARM-based design licensed from ARM Holdings, Ltd. Or customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc.

The processor 1952 may communicate with a system memory 1954 over an interconnect 1956 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., low power DDR (LPDDR), LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1958 may also couple to the processor 1952 via the interconnect 1956. In an example the storage 1958 may be implemented via a solid state disk drive (SSDD). Other devices that may be used for the storage 1958 include flash memory cards, such as SD cards, microSD cards, XD picture cards, and the like, and USB flash drives. In low power implementations, the storage 1958 may be on-die memory or registers associated with the processor 1952. However, in some examples, the storage 1958 may be implemented using a micro hard disk drive (HDD). Further, any number of new technologies may be used for the storage 1958 in addition to, or instead of, the technologies described, such resistance change memories, phase change memories, holographic memories, or chemical memories, among others.

The components may communicate over the interconnect 1956. The interconnect 1956 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1956 may be a proprietary bus, for example, used in a SoC based system. Other bus systems may be included, such as an I2C interface, an SPI interface, point to point interfaces, and a power bus, among others.

Given the variety of types of applicable communications from the device to another component or network, applicable communications circuitry used by the device may include or be embodied by any one or more of components 1962, 1966, 1968, or 1970. Accordingly, in various examples, applicable means for communicating (e.g., receiving, transmitting, etc.) may be embodied by such communications circuitry.

The interconnect 1956 may couple the processor 1952 to a mesh transceiver 1962, for communications with other mesh devices 1964. The mesh transceiver 1962 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 1964. For example, a wireless LAN (WLAN) unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The mesh transceiver 1962 may communicate using multiple standards or radios for communications at different range. For example, the IoT device 1950 may communicate with close devices, e.g., within about 10 meters, using a local transceiver based on BLE, or another low power radio, to save power. More distant mesh devices 1964, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1966 may be included to communicate with devices or services in the cloud 1900 via local or wide area network protocols. The wireless network transceiver 1966 may be a LPWA transceiver that follows the IEEE 802.15.4, or IEEE 802.15.4g standards, among others. The IoT device 1950 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1962 and wireless network transceiver 1966, as described herein. For example, the radio transceivers 1962 and 1966 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 1962 and 1966 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It may be noted that radios compatible with any number of other fixed, mobile, or satellite communication technologies and standards may be selected. These may include, for example, any Cellular Wide Arca radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 1966, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1968 may be included to provide a wired communication to the cloud 1900 or to other devices, such as the mesh devices 1964. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1968 may be included to allow connect to a second network, for example, a NIC 1968 providing communications to the cloud over Ethernet, and a second NIC 1968 providing communications to other devices over another type of network.

The interconnect 1956 may couple the processor 1952 to an external interface 1970 that is used to connect external devices or subsystems. The external devices may include sensors 1972, such as accelerometers, level sensors, flow sensors, optical light sensors, camera sensors, temperature sensors, a global positioning system (GPS) sensors, pressure sensors, barometric pressure sensors, and the like. The external interface 1970 further may be used to connect the IoT device 1950 to actuators 1974, such as power switches, valve actuators, an audible sound generator, a visual warning device, and the like.

In some optional examples, various input/output (I/O) devices may be present within, or connected to, the IoT device 1950. For example, a display or other output device 1984 may be included to show information, such as sensor readings or actuator position. An input device 1986, such as a touch screen or keypad may be included to accept input. An output device 1986 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1950.

A battery 1976 may power the IoT device 1950, although in examples in which the IoT device 1950 is mounted in a fixed location, it may have a power supply coupled to an electrical grid. The battery 1976 may be a lithium ion battery, or a metal-air battery, such as a zinc-air battery, an aluminum-air battery, a lithium-air battery, and the like.

A battery monitor/charger 1978 may be included in the IoT device 1950 to track the state of charge (SoCh) of the battery 1976. The battery monitor/charger 1978 may be used to monitor other parameters of the battery 1976 to provide failure predictions, such as the state of health (SoH) and the state of function (SoF) of the battery 1976. The battery monitor/charger 1978 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1978 may communicate the information on the battery 1976 to the processor 1952 over the interconnect 1956. The battery monitor/charger 1978 may also include an analog-to-digital (ADC) convertor that allows the processor 1952 to directly monitor the voltage of the battery 1976 or the current flow from the battery 1976. The battery parameters may be used to determine actions that the IoT device 1950 may perform, such as transmission frequency, mesh network operation, sensing frequency, and the like.

A power block 1980, or other power supply coupled to a grid, may be coupled with the battery monitor/charger 1978 to charge the battery 1976. In some examples, the power block 1980 may be replaced with a wireless power receiver to obtain the power wirelessly, for example, through a loop antenna in the IoT device 1950. A wireless battery charging circuit, such as an LTC4020 chip from Linear Technologies of Milpitas, CA, among others, may be included in the battery monitor/charger 1978. The specific charging circuits chosen depends on the size of the battery 1976, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1958 may include instructions 1982 in the form of software, firmware, or hardware commands to implement the techniques described herein. Although such instructions 1982 are shown as code blocks included in the memory 1954 and the storage 1958, it may be understood that any of the code blocks may be replaced with hardwired circuits, for example, built into an application specific integrated circuit (ASIC).

In an example, the instructions 1982 provided via the memory 1954, the storage 1958, or the processor 1952 may be embodied as a non-transitory, machine readable medium including code to direct the processor 1952 to perform electronic operations in the IoT device 1950. The processor 1952 may access the non-transitory, machine readable medium over the interconnect 1956. For instance, the non-transitory, machine readable medium may be embodied by devices described for the storage 1958 of FIG. 19 or may include specific storage units such as optical disks, flash drives, or any number of other hardware devices. The non-transitory, machine readable medium may include instructions to direct the processor 1952 to perform a specific sequence or flow of actions, for example, as described with respect to the flowchart(s) and block diagram(s) of operations and functionality depicted above.

Also in a specific example, the instructions 1982 on the processor 1952 (separately, or in combination with the instructions 1982 of the machine readable medium) may configure execution or operation of a trusted execution environment (TEE) 1990. In an example, the TEE 1990 operates as a protected area accessible to the processor 1952 for secure execution of instructions and secure access to data. Various implementations of the TEE 1990, and an accompanying secure area in the processor 1952 or the memory 1954 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1950 through the TEE 1990 and the processor 1952.

FIG. 20 is a block diagram of an example processor platform 2000 structured to execute and/or instantiate the example machine readable instructions and/or the example operations of FIGS. 14-18 to implement the DPN circuitry 200 of FIG. 2. The processor platform 2000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 2000 of the illustrated example includes processor circuitry 2012. The processor circuitry 2012 of the illustrated example is hardware. For example, the processor circuitry 2012 can be implemented by one or more integrated circuits, logic circuits, FPGAs, microprocessors, CPUs, GPUs, DSPs, and/or microcontrollers from any desired family or manufacturer. The processor circuitry 2012 may be implemented by one or more semiconductor based (e.g., silicon based) devices. In this example, the processor circuitry 2012 implements the example parser circuitry 220, the example private network configuration circuitry 230 (identified by PN CONFIG CIRCUITRY), the example credential generation circuitry 240 (identified by CREDENTIAL GEN CIRCUITRY), the example private network management circuitry 250 (identified by PN MANAGEMENT CIRCUITRY), the example location determination circuitry 260 (identified by LOC DETERM CIRCUITRY), and the example access verification circuitry 270 (identified by ACCESS VERIFY CIRCUITRY) of FIG. 2.

The processor circuitry 2012 of the illustrated example includes a local memory 2013 (e.g., a cache, registers, etc.). The processor circuitry 2012 of the illustrated example is in communication with a main memory including a volatile memory 2014 and a non-volatile memory 2016 by a bus 2018. In some examples, the bus 2018 can implement the bus 298 of FIG. 2. The volatile memory 2014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2016 may be implemented by flash memory and/or any other desired type of memory device. Access to the main memory 2014, 2016 of the illustrated example is controlled by a memory controller 2017.

The processor platform 2000 of the illustrated example also includes interface circuitry 2020. The interface circuitry 2020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 2020 implements the example receiver circuitry 210 (identified by RX CIRCUITRY) and the transmitter circuitry 280 (identified by TX CIRCUITRY) of FIG. 2.

In the illustrated example, one or more input devices 2022 are connected to the interface circuitry 2020. The input device(s) 2022 permit(s) a user to enter data and/or commands into the processor circuitry 2012. The input device(s) 2022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 2024 are also connected to the interface circuitry 2020 of the illustrated example. The output device(s) 2024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2020 of the illustrated example, thus, typically includes a graphics driver card, a graphics driver chip, and/or graphics processor circuitry such as a GPU.

The interface circuitry 2020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 2000 of the illustrated example also includes one or more mass storage devices 2028 to store software and/or data. Examples of such mass storage devices 2028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 2028 implement the example datastore 290 of FIG. 2, which includes the multi-spectrum data 292 (identified by MS DATA) and the example access credentials 294 (identified by ACC CREDS) of FIG. 2.

The machine readable instructions 2032, which may be implemented by the machine readable instructions of FIGS. 14-18, may be stored in the mass storage device 2028, in the volatile memory 2014, in the non-volatile memory 2016, and/or on a removable non-transitory computer readable storage medium such as a CD or DVD.

FIG. 21 is a block diagram of an example implementation of the processor circuitry 1960 of FIG. 19 and/or the processor circuitry 2012 of FIG. 20. In this example, the processor circuitry 1960 of FIG. 19 and/or the processor circuitry 2012 of FIG. 20 is implemented by a microprocessor 2100. For example, the microprocessor 2100 may be a general purpose microprocessor (e.g., general purpose microprocessor circuitry). The microprocessor 2100 executes some or all of the machine readable instructions of the flowcharts of FIGS. 14-18 to effectively instantiate the DPN circuitry 200 of FIG. 2 as logic circuits to perform the operations corresponding to those machine readable instructions. In some such examples, the DPN circuitry 200 of FIG. 2 is instantiated by the hardware circuits of the microprocessor 2100 in combination with the instructions. For example, the microprocessor 2100 may be implemented by multi-core hardware circuitry such as a CPU, a DSP, a GPU, an XPU, etc. Although it may include any number of example cores 2102 (e.g., 1 core), the microprocessor 2100 of this example is a multi-core semiconductor device including N cores. The cores 2102 of the microprocessor 2100 may operate independently or may cooperate to execute machine readable instructions. For example, machine code corresponding to a firmware program, an embedded software program, or a software program may be executed by one of the cores 2102 or may be executed by multiple ones of the cores 2102 at the same or different times. In some examples, the machine code corresponding to the firmware program, the embedded software program, or the software program is split into threads and executed in parallel by two or more of the cores 2102. The software program may correspond to a portion or all of the machine readable instructions and/or operations represented by the flowcharts of FIGS. 14-18.

The cores 2102 may communicate by a first example bus 2104. In some examples, the first bus 2104 may be implemented by a communication bus to effectuate communication associated with one(s) of the cores 2102. For example, the first bus 2104 may be implemented by at least one of an Inter-Integrated Circuit (I2C) bus, a Serial Peripheral Interface (SPI) bus, a PCI bus, or a PCIe bus. Additionally or alternatively, the first bus 2104 may be implemented by any other type of computing or electrical bus. The cores 2102 may obtain data, instructions, and/or signals from one or more external devices by example interface circuitry 2106. The cores 2102 may output data, instructions, and/or signals to the one or more external devices by the interface circuitry 2106. Although the cores 2102 of this example include example local memory 2120 (e.g., Level 1 (L1) cache that may be split into an L1 data cache and an L1 instruction cache), the microprocessor 2100 also includes example shared memory 2110 that may be shared by the cores (e.g., Level 2 (L2 cache)) for high-speed access to data and/or instructions. Data and/or instructions may be transferred (e.g., shared) by writing to and/or reading from the shared memory 2110. The local memory 2120 of each of the cores 2102 and the shared memory 2110 may be part of a hierarchy of storage devices including multiple levels of cache memory and the main memory (e.g., the main memory 2014, 2016 of FIG. 20). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2102 may be referred to as a CPU, DSP, GPU, etc., or any other type of hardware circuitry. Each core 2102 includes control unit circuitry 2114, arithmetic and logic (AL) circuitry (sometimes referred to as an ALU) 2116, a plurality of registers 2118, the local memory 2120, and a second example bus 2122. Other structures may be present. For example, each core 2102 may include vector unit circuitry, single instruction multiple data (SIMD) unit circuitry, load/store unit (LSU) circuitry, branch/jump unit circuitry, floating-point unit (FPU) circuitry, etc. The control unit circuitry 2114 includes semiconductor-based circuits structured to control (e.g., coordinate) data movement within the corresponding core 2102. The AL circuitry 2116 includes semiconductor-based circuits structured to perform one or more mathematic and/or logic operations on the data within the corresponding core 2102. The AL circuitry 2116 of some examples performs integer based operations. In other examples, the AL circuitry 2116 also performs floating point operations. In yet other examples, the AL circuitry 2116 may include first AL circuitry that performs integer based operations and second AL circuitry that performs floating point operations. In some examples, the AL circuitry 2116 may be referred to as an Arithmetic Logic Unit (ALU). The registers 2118 are semiconductor-based structures to store data and/or instructions such as results of one or more of the operations performed by the AL circuitry 2116 of the corresponding core 2102. For example, the registers 2118 may include vector register(s), SIMD register(s), general purpose register(s), flag register(s), segment register(s), machine specific register(s), instruction pointer register(s), control register(s), debug register(s), memory management register(s), machine check register(s), etc. The registers 2118 may be arranged in a bank as shown in FIG. 21. Alternatively, the registers 2118 may be organized in any other arrangement, format, or structure including distributed throughout the core 2102 to shorten access time. The second bus 2122 may be implemented by at least one of an I2C bus, a SPI bus, a PCI bus, or a PCIe bus

Each core 2102 and/or, more generally, the microprocessor 2100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 2100 is a semiconductor device fabricated to include many transistors interconnected to implement the structures described above in one or more integrated circuits (Ics) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

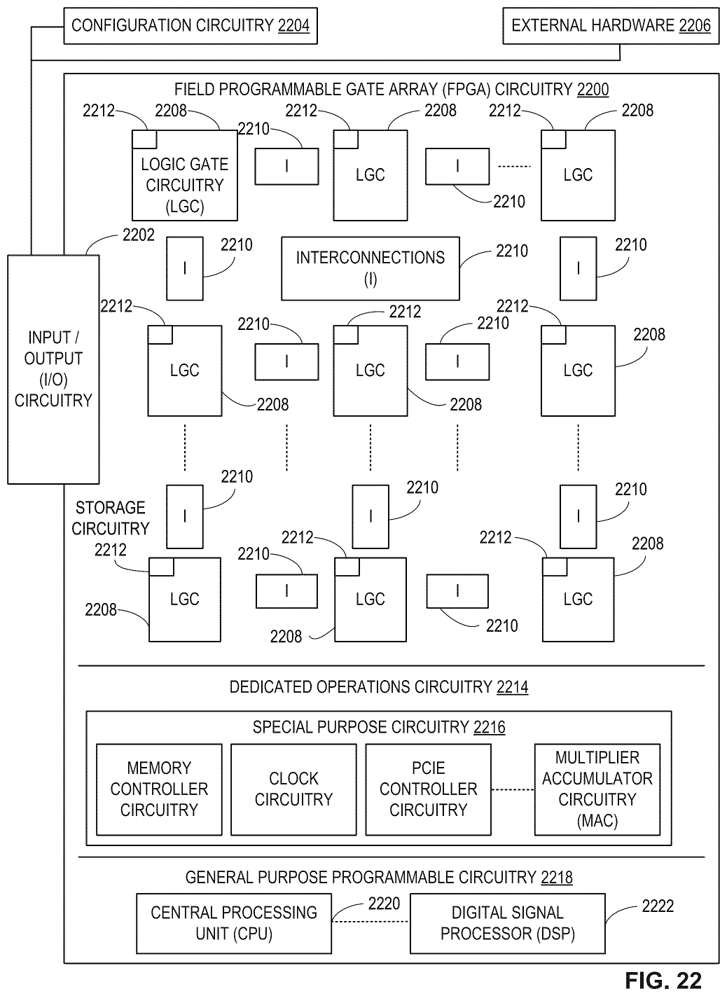

FIG. 22 is a block diagram of another example implementation of the processor circuitry 1960 of FIG. 19 and/or the processor circuitry 2012 of FIG. 20. In this example, the processor circuitry 1960 of FIG. 19 and/or the processor circuitry 2012 of FIG. 20 is implemented by FPGA circuitry 2200. For example, the FPGA circuitry 2200 may be implemented by an FPGA. The FPGA circuitry 2200 can be used, for example, to perform operations that could otherwise be performed by the example microprocessor 2100 of FIG. 21 executing corresponding machine readable instructions. However, once configured, the FPGA circuitry 2200 instantiates the machine readable instructions in hardware and, thus, can often execute the operations faster than they could be performed by a general purpose microprocessor executing the corresponding software.

More specifically, in contrast to the microprocessor 2100 of FIG. 21 described above (which is a general purpose device that may be programmed to execute some or all of the machine readable instructions represented by the flowcharts of FIGS. 14-18 but whose interconnections and logic circuitry are fixed once fabricated), the FPGA circuitry 2200 of the example of FIG. 22 includes interconnections and logic circuitry that may be configured and/or interconnected in different ways after fabrication to instantiate, for example, some or all of the machine readable instructions represented by the flowcharts of FIGS. 14-18. In particular, the FPGA circuitry 2200 may be thought of as an array of logic gates, interconnections, and switches. The switches can be programmed to change how the logic gates are interconnected by the interconnections, effectively forming one or more dedicated logic circuits (unless and until the FPGA circuitry 2200 is reprogrammed). The configured logic circuits enable the logic gates to cooperate in different ways to perform different operations on data received by input circuitry. Those operations may correspond to some or all of the software represented by the flowcharts of FIGS. 14-18. As such, the FPGA circuitry 2200 may be structured to effectively instantiate some or all of the machine readable instructions of the flowcharts of FIGS. 14-18 as dedicated logic circuits to perform the operations corresponding to those software instructions in a dedicated manner analogous to an ASIC. Therefore, the FPGA circuitry 2200 may perform the operations corresponding to the some or all of the machine readable instructions of FIGS. 14-18 faster than the general purpose microprocessor can execute the same.

In the example of FIG. 22, the FPGA circuitry 2200 is structured to be programmed (and/or reprogrammed one or more times) by an end user by a hardware description language (HDL) such as Verilog. The FPGA circuitry 2200 of FIG. 22, includes example input/output (I/O) circuitry 2202 to obtain and/or output data to/from example configuration circuitry 2204 and/or external hardware 2206. For example, the configuration circuitry 2204 may be implemented by interface circuitry that may obtain machine readable instructions to configure the FPGA circuitry 2200, or portion(s) thereof. In some such examples, the configuration circuitry 2204 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 2206 may be implemented by external hardware circuitry. For example, the external hardware 2206 may be implemented by the microprocessor 2100 of FIG. 21. The FPGA circuitry 2200 also includes an array of example logic gate circuitry 2208, a plurality of example configurable interconnections 2210, and example storage circuitry 2212. The logic gate circuitry 2208 and the configurable interconnections 2210 are configurable to instantiate one or more operations that may correspond to at least some of the machine readable instructions of FIGS. 14-18 and/or other desired operations. The logic gate circuitry 2208 shown in FIG. 22 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2208 to enable configuration of the electrical structures and/or the logic gates to form circuits to perform desired operations. The logic gate circuitry 2208 may include other electrical structures such as look-up tables (LUTs), registers (e.g., flip-flops or latches), multiplexers, etc.

The configurable interconnections 2210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2208 to program desired logic circuits.

The storage circuitry 2212 of the illustrated example is structured to store result(s) of the one or more of the operations performed by corresponding logic gates. The storage circuitry 2212 may be implemented by registers or the like. In the illustrated example, the storage circuitry 2212 is distributed amongst the logic gate circuitry 2208 to facilitate access and increase execution speed.

The example FPGA circuitry 2200 of FIG. 22 also includes example Dedicated Operations Circuitry 2214. In this example, the Dedicated Operations Circuitry 2214 includes special purpose circuitry 2216 that may be invoked to implement commonly used functions to avoid the need to program those functions in the field. Examples of such special purpose circuitry 2216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2200 may also include example general purpose programmable circuitry 2218 such as an example CPU 2220 and/or an example DSP 2222. Other general purpose programmable circuitry 2218 may additionally or alternatively be present such as a GPU, an XPU, etc., that can be programmed to perform other operations.

Although FIGS. 21 and 22 illustrate two example implementations of the processor circuitry 1960 of FIG. 19 and/or the processor circuitry 2012 of FIG. 20, many other approaches are contemplated. For example, as mentioned above, modern FPGA circuitry may include an on-board CPU, such as one or more of the example CPU 2220 of FIG. 22. Therefore, the processor circuitry 1960 of FIG. 19 and/or the processor circuitry 2012 of FIG. 20 may additionally be implemented by combining the example microprocessor 2100 of FIG. 21 and the example FPGA circuitry 2200 of FIG. 22. In some such hybrid examples, a first portion of the machine readable instructions represented by the flowcharts of FIGS. 14-18 may be executed by one or more of the cores 2102 of FIG. 21, a second portion of the machine readable instructions represented by the flowcharts of FIGS. 14-18 may be executed by the FPGA circuitry 2200 of FIG. 22, and/or a third portion of the machine readable instructions represented by the flowcharts of FIGS. 14-18 may be executed by an ASIC. It should be understood that some or all of the DPN circuitry 200 of FIG. 2 may, thus, be instantiated at the same or different times. Some or all of the circuitry may be instantiated, for example, in one or more threads executing concurrently and/or in series. Moreover, in some examples, some or all of the DPN circuitry 200 of FIG. 2 may be implemented within one or more virtual machines and/or containers executing on the microprocessor.

In some examples, the processor circuitry 1960 of FIG. 19 and/or the processor circuitry 2012 of FIG. 20 may be in one or more packages. For example, the microprocessor 2100 of FIG. 21 and/or the FPGA circuitry 2200 of FIG. 22 may be in one or more packages. In some examples, an XPU may be implemented by the processor circuitry 1960 of FIG. 19 and/or the processor circuitry 2012 of FIG. 20, which may be in one or more packages. For example, the XPU may include a CPU in one package, a DSP in another package, a GPU in yet another package, and an FPGA in still yet another package.

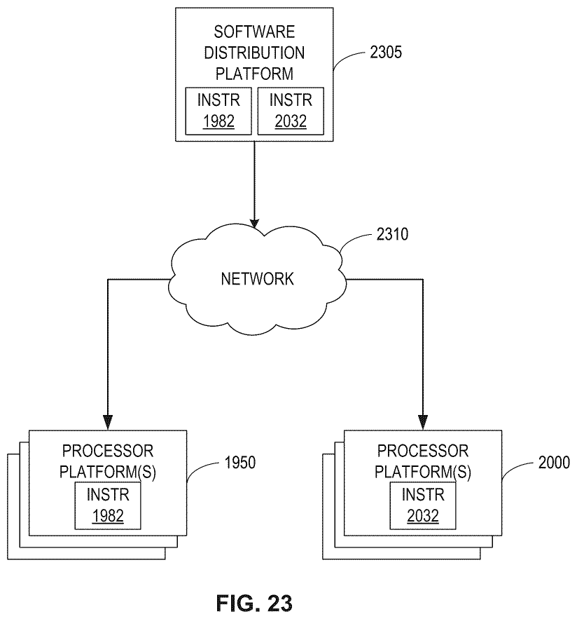

A block diagram illustrating an example software distribution platform 2305 to distribute software such as the example machine readable instructions 1982 of FIG. 19 and/or the example machine readable instructions 2032 of FIG. 20 to hardware devices owned and/or operated by third parties is illustrated in FIG. 23. The example software distribution platform 2305 may be implemented by any computer server, data facility, cloud service, etc., capable of storing and transmitting software to other computing devices. The third parties may be customers of the entity owning and/or operating the software distribution platform 2305. For example, the entity that owns and/or operates the software distribution platform 2305 may be a developer, a seller, and/or a licensor of software such as the example machine readable instructions 1982 of FIG. 19 and/or the example machine readable instructions 2032 of FIG. 20. The third parties may be consumers, users, retailers, OEMs, etc., who purchase and/or license the software for use and/or re-sale and/or sub-licensing. In the illustrated example, the software distribution platform 2305 includes one or more servers and one or more storage devices. The storage devices store the machine readable instructions 1982 of FIG. 19, which may correspond to the example machine readable instructions 1400, 1500, 1600, 1700, 1800 of FIGS. 14-18, as described above. The storage devices store the machine readable instructions 2032 of FIG. 20, which may correspond to the example machine readable instructions 1400, 1500, 1600, 1700, 1800 of FIGS. 14-18, as described above. The one or more servers of the example software distribution platform 2305 are in communication with an example network 2310, which may correspond to any one or more of the Internet and/or any of the example networks 810, 1900, 2026 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the example machine readable instructions 1982 of FIG. 19 and/or the example machine readable instructions 2032 of FIG. 20 from the software distribution platform 2305. For example, the software, which may correspond to the example machine readable instructions 1400, 1500, 1600, 1700, 1800 of FIGS. 14-18, may be downloaded to the example processor platform 1950, which is to execute the machine readable instructions 1982 to implement the DPN circuitry 200. In some examples, the software, which may correspond to the example machine readable instructions 1400, 1500, 1600, 1700, 1800 of FIGS. 14-18, may be downloaded to the example processor platform 2000, which is to execute the machine readable instructions 2032 to implement the DPN circuitry 200. In some examples, one or more servers of the software distribution platform 2305 periodically offer, transmit, and/or force updates to the software (e.g., the example machine readable instructions 1982 of FIG. 19 and/or the example machine readable instructions 2032 of FIG. 20) to ensure improvements, patches, updates, etc., are distributed and applied to the software at the end user devices.

From the foregoing, it will be appreciated that example systems, methods, apparatus, and articles of manufacture have been disclosed for device authentication in a dedicated private network. Disclosed systems, methods, apparatus, and articles of manufacture effectuate eSIM provisioning over Wi-Fi (e.g., via standalone IT Wi-Fi AP, N3IWF, and/or TNGF) using single ID, followed by automated, hassle free eSIM registration by UE with the 5GC of DPN 5G Private Network for 5G access. Disclosed systems, methods, apparatus, and articles of manufacture effectuate an enhanced security feature by embedding location data into the eSIM and periodically cross verifying the location info by the 5GC with eSIM. Advantageously, the cross verifying can prevent any unauthorized UE that attempts to register with DPN 5G Private Network. Disclosed systems, methods, apparatus, and articles of manufacture improve the efficiency of using a computing device by effectuating access to multiple types of networks based on a single set of access credentials. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for device authentication in a dedicated private network are disclosed herein. Further examples and combinations thereof include the following:

Example 1 is a method comprising generating a first set of network access credentials associated with a first network protocol based on a second set of network access credentials associated with a second network protocol, generating an eSIM based on the first set of network access credentials, the eSIM to provide access to a dedicated private network, causing a registration of the eSIM with the device, and facilitating communication associated with the device using the dedicated private network.

In Example 2, the subject matter of Example 1 can optionally include that the first set of network access credentials are 5G access credentials and the first network protocol is a 5G cellular protocol.

In Example 3, the subject matter of Examples 1-2 can optionally include that the second set of network access credentials are Wi-Fi access credentials and the second network protocol is a Wi-Fi protocol.

In Example 4, the subject matter of Examples 1-3 can optionally include setting periodic location verification of the device for specified measurement periodicities.

In Example 5, the subject matter of Examples 1-4 can optionally include provisioning the eSIM over an established Wi-Fi network data plane to the device.

In Example 6, the subject matter of Examples 1-5 can optionally include cross referencing the first set of network access credentials with network functions associated with the first network protocol.

In Example 7, the subject matter of Examples 1-6 can optionally include that the network functions include at least one of AMF, LMF, UDM, or AUSF of a network control plane.

In Example 8, the subject matter of Examples 1-7 can optionally include determining a geographical area of a private network.

In Example 9, the subject matter of Examples 1-8 can optionally include generating a terrestrial network coverage grid.

In Example 10, the subject matter of Examples 1-9 can optionally include generating a non-terrestrial network coverage grid.

In Example 11, the subject matter of Examples 1-10 can optionally include activating private network terrestrial network nodes in alignment with the terrestrial network coverage grid.

In Example 12, the subject matter of Examples 1-11 can optionally include activating private network non-terrestrial network nodes in alignment with the non-terrestrial network coverage grid.

In Example 13, the subject matter of Examples 1-12 can optionally include parsing data obtained from the device, and determining a time-of-arrival associated with data from the device.

In Example 14, the subject matter of Examples 1-13 can optionally include determining an angle-of-arrival associated with the data.

In Example 15, the subject matter of Examples 1-14 can optionally include determining a time-difference-of-arrival associated with the data.

In Example 16, the subject matter of Examples 1-15 can optionally include determining at least one of a direction or a location of the devices based on at least one of the time-of-arrival, the angle-of-arrival, or the time-difference-of-arrival associated with the data.

In Example 17, the subject matter of Examples 1-16 can optionally include publishing the at least one of the direction or the location of the device to a datastore for application access.

In Example 18, the subject matter of Examples 1-17 can optionally include that the data is multi-spectrum data.

In Example 19, the subject matter of Examples 1-18 can optionally include generating a motion vector of the device.

In Example 20, the subject matter of Examples 1-19 can optionally include that the data is at least one of Wi-Fi, Bluetooth, satellite, cellular, or sensor data.

In Example 21, the subject matter of Examples 1-20 can optionally include that the data from at least one of a radio access network, a Bluetooth beacon, a Wi-Fi access point, a geostationary earth orbit (GEO) satellite, a low earth orbit (LEO) satellite, a medium earth orbit (MEO) satellite, a highly elliptical orbit (HEO) satellite, a GPS satellite, a camera, a light detection and ranging sensor, or a radiofrequency identification sensor.

In Example 22, the subject matter of Examples 1-21 can optionally include determining whether a location determination policy associated with the device includes at least one of a location accuracy requirement, a latency requirement, a power consumption requirement, a QoS requirement, or a throughput requirement.

In Example 23, the subject matter of Examples 1-22 can optionally include initiating the device to send sounding reference signal (SRS) data.

In Example 24, the subject matter of Examples 1-23 can optionally include initiating the device to send sounding reference signal (SRS) data on a periodic basis.

In Example 25, the subject matter of Examples 1-24 can optionally include initiating the device to send sounding reference signal (SRS) data on an aperiodic basis.

In Example 26, the subject matter of Examples 1-25 can optionally include enqueuing or dequeuing sounding reference signal (SRS) data with hardware queue management circuitry.

In Example 27, the subject matter of Examples 1-26 can optionally include configuring a programmable data collector based on a policy, and, in response to a determination that a time period based on the policy to access cellular data has elapsed, access the cellular data.

In Example 28, the subject matter of Examples 1-27 can optionally include initializing the programmable data collector.

In Example 29, the subject matter of Examples 1-28 can optionally include instantiating the programmable data collector using dedicated private network circuitry.

In Example 30, the subject matter of Examples 1-29 can optionally include not accessing the data after a determination that the time period based on a policy has not elapsed.

In Example 31, the subject matter of Examples 1-30 can optionally include accessing the data by enqueueing the data with hardware queue management circuitry.

In Example 32, the subject matter of Examples 1-31 can optionally include that accessing the data includes storing the data for access by a logical entity in at least one of memory or a mass storage disc.

In Example 33, the subject matter of Examples 1-32 can optionally include that accessing the data includes dequeuing the data with the hardware queue management circuitry.

In Example 34, the subject matter of Examples 1-33 can optionally include that the data is fifth generation cellular (5G) Layer 1 (L1) data.

In Example 35, the subject matter of Examples 1-34 can optionally include that the fifth generation cellular (5G) Layer 1 (L1) data is sounding reference signal (SRS) data.

In Example 36, the subject matter of Examples 1-35 can optionally include that the access of the data is substantially simultaneously with a receipt of the data by interface circuitry.

Example 37 includes a method comprising generating, by executing an instruction with programmable circuitry, first credentials associated with a first network based on second credentials associated with a second network, the first credentials including first location data corresponding to a dedicated private network (DPN), causing, by executing an instruction with the programmable circuitry, a mobile device to program a programmable subscriber identity module (SIM) of the mobile device based on the first credentials, and permitting, by executing an instruction with the programmable circuitry, the mobile device to access the DPN based on a determination that second location data corresponding to the mobile device and included with the programmable SIM corresponds to the first location data.

In Example 38, the subject matter of Example 37 can optionally include repeatedly verifying that the second location data corresponds to the first location data.

In Example 39, the subject matter of Examples 37-38 can optionally include preventing the mobile device from accessing the DPN based on the second location data not corresponding to the first location data.

In Example 40, the subject matter of Examples 37-39 can optionally include that the first location data is indicative of a geographic area associated with the DPN, the second location data is indicative of a location of the mobile device, and the method further includes determining that the second location data corresponds to the first location data based on whether the location is within the geographic area.

In Example 41, the subject matter of Examples 37-40 can optionally include providing the second credentials to at least one of a hash algorithm or hash function to generate the first credentials.

In Example 42, the subject matter of Examples 37-41 can optionally include generating the first credentials based on whether the second credentials correspond to a wireless fidelity (Wi-Fi) network associated with the DPN.

In Example 43, the subject matter of Examples 37-42 can optionally include generating a quick response code based on the first credentials, the quick response code to cause the mobile device to program the programmable SIM based on the first credentials.

In Example 44, the subject matter of Examples 37-43 can optionally include that the first credentials are first access credentials associated with a cellular network, and the second credentials are second access credentials associated with a wireless fidelity (Wi-Fi) network.

In Example 45, the subject matter of Examples 37-42 can optionally include transmitting a code to the mobile device via a wireless fidelity (Wi-Fi) network not included in the DPN, the code to cause the mobile device to program the programmable SIM based on the first credentials.

In Example 46, the subject matter of Examples 37-42 can optionally include transmitting a code to the mobile device via a non-trusted access point included in the DPN, the code to cause the mobile device to program the programmable SIM based on the first credentials.

In Example 47, the subject matter of Examples 37-42 can optionally include transmitting a code to the mobile device via a trusted access point included in the DPN, the code to cause the mobile device to program the programmable SIM based on the first credentials.

In Example 48, the subject matter of Examples 37-47 can optionally include that the DPN includes at least one of a terrestrial network or a non-terrestrial network, and the method further includes determining the second location data based on at least one of a time-of-arrival, an angle-of-arrival, a time-difference-of-arrival, or a multi-cell round trip time associated with communications from the mobile device, the mobile device attached to at least one of the terrestrial network or the non-terrestrial network.

Example 49 is at least one computer readable medium comprising instructions to perform the method of any of Examples 1-36 or the method of any of Examples 37-48.

Example 50 is edge server processor circuitry to perform the method of any of Examples 1-36 or the method of any of Examples 37-48.

Example 51 is an edge cloud processor circuitry to perform the method of any of Examples 1-36 or the method of any of Examples 37-48.

Example 52 is edge node processor circuitry to perform the method of any of Examples 1-36 or the method of any of Examples 37-48.

Example 53 is dedicated private network circuitry to perform the method of any of Examples 1-36 or the method of any of Examples 37-48.

Example 54 is a programmable data collector to perform the method of any of Examples 1-36 or the method of any of Examples 37-48.

Example 55 is an apparatus comprising processor circuitry to perform the method of any of Examples 1-36 or the method of any of Examples 37-48.

Example 56 is an apparatus comprising one or more edge gateways to perform the method of any of Examples 1-36 or the method of any of Examples 37-48.

Example 57 is an apparatus comprising one or more edge switches to perform the method of any of Examples 1-36 or the method of any of Examples 37-48.

Example 58 is an apparatus comprising at least one of one or more edge gateways or one or more edge switches to perform the method of any of Examples 1-36 or the method of any of Examples 37-48.

Example 59 is an apparatus comprising accelerator circuitry to perform the method of any of Examples 1-36 or the method of any of Examples 37-48.

Example 60 is an apparatus comprising one or more graphics processor units to perform the method of any of Examples 1-36 or the method of any of Examples 37-48.

Example 61 is an apparatus comprising one or more Artificial Intelligence processors to perform the method of any of Examples 1-36 or the method of any of Examples 37-48.

Example 62 is an apparatus comprising one or more machine learning processors to perform the method of any of Examples 1-36 or the method of any of Examples 37-48.

Example 63 is an apparatus comprising one or more neural network processors to perform the method of any of Examples 1-36 or the method of any of Examples 37-48.

Example 64 is an apparatus comprising one or more digital signal processors to perform the method of any of Examples 1-36 or the method of any of Examples 37-48.

Example 65 is an apparatus comprising one or more general purpose processors to perform the method of any of Examples 1-36 or the method of any of Examples 37-48.

Example 66 is an apparatus comprising network interface circuitry to perform the method of any of Examples 1-36 or the method of any of Examples 37-48.

Example 67 is an Infrastructure Processor Unit to perform the method of any of Examples 1-36 or the method of any of Examples 37-48.

Example 68 is hardware queue management circuitry to perform the method of any of Examples 1-36 or the method of any of Examples 37-48.

Example 69 is at least one of remote radio unit circuitry or radio access network circuitry to perform the method of any of Examples 1-36 or the method of any of Examples 37-48.

Example 70 is base station circuitry to perform the method of any of Examples 1-36 or the method of any of Examples 37-48.

Example 71 is user equipment circuitry to perform the method of any of Examples 1-36 or the method of any of Examples 37-48.

Example 72 is an Internet of Things device to perform the method of any of Examples 1-36 or the method of any of Examples 37-48.

Example 73 is a software distribution platform to distribute machine-readable instructions that, when executed by processor circuitry, cause the processor circuitry to perform the method of any of Examples 1-36 or the method of any of Examples 37-48.

Example 74 is edge cloud circuitry to perform the method of any of Examples 1-36 or the method of any of Examples 37-48.

Example 75 is distributed unit circuitry to perform the method of any of Examples 1-36 or the method of any of Examples 37-48.

Example 76 is control unit circuitry to perform the method of any of Examples 1-36 or the method of any of Examples 37-48.

Example 77 is core server circuitry to perform the method of any of Examples 1-36 or the method of any of Examples 37-48.

Example 78 is satellite circuitry to perform the method of any of Examples 1-36 or the method of any of Examples 37-48.

Example 79 is at least one of one more GEO satellites or one or more LEO satellites to perform the method of any of Examples 1-36 or the method of any of Examples 37-48.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
interface circuitry;
machine readable instructions; and
at least one processor circuit to be programmed based on the machine readable instructions to:
generate first credentials associated with a first network based on second credentials associated with a second network, the first credentials including first location data corresponding to a dedicated private network (DPN);
cause a mobile device to program a programmable subscriber identity module (SIM) of the mobile device based on the first credentials; and
permit the mobile device to access the DPN based on a determination that second location data corresponding to the mobile device and included with the programmable SIM corresponds to the first location data.

2. The apparatus of claim 1, wherein one or more of the at least one processor circuit is to repeatedly verify that the second location data corresponds to the first location data.

3. The apparatus of claim 1, wherein one or more of the at least one processor circuit is to prevent the mobile device from accessing the DPN based on the second location data not corresponding to the first location data.

4. The apparatus of claim 1, wherein the first location data is indicative of a geographic area associated with the DPN, the second location data is indicative of a location of the mobile device, and one or more of the at least one processor circuit is to determine that the second location data corresponds to the first location data based on whether the location is within the geographic area.

5. The apparatus of claim 1, wherein one or more of the at least one processor circuit is to provide the second credentials to at least one of a hash algorithm or hash function to generate the first credentials.

6. The apparatus of claim 1, wherein one or more of the at least one processor circuit is to generate the first credentials based on whether the second credentials correspond to a wireless fidelity (Wi-Fi) network associated with the DPN.

7. The apparatus of claim 1, wherein one or more of the at least one processor circuit is to generate a quick response code based on the first credentials, the quick response code to cause the mobile device to program the programmable SIM based on the first credentials.

8. The apparatus of claim 1, wherein the first credentials are first access credentials associated with a cellular network, and the second credentials are second access credentials associated with a wireless fidelity (Wi-Fi) network.

9. The apparatus of claim 1, wherein one or more of the at least one processor circuit is to cause transmission of a code to the mobile device via a wireless fidelity (Wi-Fi) network not included in the DPN, the code to cause the mobile device to program the programmable SIM based on the first credentials.

10. The apparatus of claim 1, wherein one or more of the at least one processor circuit is to cause transmission of a code to the mobile device via a non-trusted access point included in the DPN, the code to cause the mobile device to program the programmable SIM based on the first credentials.

11. The apparatus of claim 1, wherein one or more of the at least one processor circuit is to cause transmission of a code to the mobile device via a trusted access point included in the DPN, the code to cause the mobile device to program the programmable SIM based on the first credentials.

12. The apparatus of claim 1, wherein the DPN includes at least one of a terrestrial network or a non-terrestrial network, and one or more of the at least one processor circuit is to determine the second location data based on at least one of a time-of-arrival, an angle-of-arrival, a time-difference-of-arrival, or a multi-cell round trip time associated with communications from the mobile device, the mobile device attached to at least one of the terrestrial network or the non-terrestrial network.

13. A non-transitory computer readable medium comprising instructions to cause at least one processor circuit to at least:
generate first credentials associated with a first network based on second credentials associated with a second network, the first credentials including first location data corresponding to a dedicated private network (DPN);
cause a mobile device to program a programmable subscriber identity module (SIM) of the mobile device based on the first credentials; and
permit the mobile device to access the DPN based on a determination that second location data corresponding to the mobile device and included with the programmable SIM corresponds to the first location data.

14. The non-transitory computer readable medium of claim 13, wherein the instructions are to cause one or more of the at least one processor circuit to prevent the mobile device from accessing the DPN based on the second location data not corresponding to the first location data.

15. The non-transitory computer readable medium of claim 13, wherein the first location data is indicative of a geographic area associated with the DPN, the second location data is indicative of a location of the mobile device, and the instructions are to cause one or more of the at least one processor circuit to determine that the second location data corresponds to the first location data based on whether the location is within the geographic area.

16. The non-transitory computer readable medium of claim 13, wherein the first credentials are first access credentials associated with a cellular network, and the second credentials are second access credentials associated with a wireless fidelity (Wi-Fi) network.

17. A method comprising:
generating, by executing an instruction with at least one processor circuit, first credentials associated with a first network based on second credentials associated with a second network, the first credentials including first location data corresponding to a dedicated private network (DPN);
causing, by executing an instruction with one or more of the at least one processor circuit, a mobile device to program a programmable subscriber identity module (SIM) of the mobile device based on the first credentials; and
permitting, by executing an instruction with one or more of the at least one processor circuit, the mobile device to access the DPN based on a determination that second location data corresponding to the mobile device and included with the programmable SIM corresponds to the first location data.

18. The method of claim 17, including preventing the mobile device from accessing the DPN based on the second location data not corresponding to the first location data.

19. The method of claim 17, wherein the first location data is indicative of a geographic area associated with the DPN, the second location data is indicative of a location of the mobile device, and the method includes determining that the second location data corresponds to the first location data based on whether the location is within the geographic area.

20. The method of claim 17, wherein the first credentials are first access credentials associated with a cellular network, and the second credentials are second access credentials associated with a wireless fidelity (Wi-Fi network).
